(19) United States
(12) Patent Application Publication
(10) Pub. No.: US 2021/0124348 A1
(43) Pub. Date: Apr. 29, 2021

(54) Autonomous Clustering for Light Electric Vehicles

(71) Applicant: Uber Technologies, Inc., San Francisco, CA (US)

(72) Inventors: Sean Hyde, Pittsburgh, PA (US); Ronnie Cameron, San Francisco, CA (US); Eric Meyhofer, Pittsburgh, PA (US); Nick Foley, San Francisco, CA (US); Alan Hugh Wells, San Rafael, CA (US)

(21) Appl. No.: 16/661,429

(22) Filed: Oct. 23, 2019

(51) Int. Cl. G05D 1/00; G05D 1/02; G01C 21/20

(52) U.S. Cl. CPC G05D 1/0027; G05D 1/0033; G05D 2201/0209; G01C 21/20; G05D 1/0278

(57) ABSTRACT

Systems and methods for clustering autonomous light electric vehicles are provided. A method can include obtaining, by a computing system, data indicative of a respective location for each of a plurality of autonomous light electric vehicles; determining, by the computing system, at least a subset of the plurality of autonomous light electric vehicles to cluster within a geographic area based at least in part on the data indicative of the respective location for each of the plurality of autonomous light electric vehicles; determining, by the computing system, a point autonomous light electric vehicle and one or more follower autonomous light electric vehicles based at least in part on one or more properties of the subset of the autonomous light electric vehicles; and controlling, by the computing system, each of the follower autonomous light electric vehicles to within a threshold distance of the point autonomous light electric vehicle.

### FIELD

The present disclosure relates generally to devices, systems, and methods autonomous navigation using sensor data from an autonomous light electric vehicle.

### BACKGROUND

Light electric vehicles (LEVs) can include passenger carrying vehicles that are powered by a battery, fuel cell, and/or hybrid-powered. LEVs can include, for example, bikes and scooters. Entities can make LEVs available for use by individuals. For instance, an entity can allow an individual to rent/lease an LEV upon request on an on-demand type basis. The individual can pick-up the LEV at one location, utilize it for transportation, and leave the LEV at another location so that the entity can make the LEV available for use by other individuals.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for clustering a plurality of autonomous light electric vehicles. The computer-implemented method can include obtaining, by a computing system comprising one or more computing devices, data indicative of a respective location for each of a plurality of autonomous light electric vehicles. The computer-implemented method can further include determining, by the computing system, at least a subset of the plurality of autonomous light electric vehicles to cluster within a geographic area based at least in part on the data indicative of the respective location for each of the plurality of autonomous light electric vehicles. The computer-implemented method can further include determining, by the computing system, a point autonomous light electric vehicle and one or more follower autonomous light electric vehicles based at least in part on one or more properties of the subset of the autonomous light electric vehicles. The point autonomous light electric vehicle can be an autonomous light electric vehicle of the subset. Each of the autonomous light electric vehicles of the subset which are not the point autonomous light electric vehicle can be a follower autonomous light electric vehicle. The computer-implemented method can further include controlling, by the computing system, each of the follower autonomous light electric vehicles to within a threshold distance of the point autonomous light electric vehicle.

Another example aspect of the present disclosure is directed to a computing system. The computing system can include one or more processors and one or more tangible, non-transitory, computer readable media that store instructions that when executed by the one or more processors cause the computing system to perform operations. The operations can include obtaining data indicative of a respective location for each of a plurality of autonomous light electric vehicles. The operations can further include determining a cluster location for the plurality of autonomous light electric vehicles based at least in part on the data indicative of the respective location for each of the autonomous light electric vehicles of the plurality and one or more additional properties associated with the plurality of autonomous light electric vehicles. The operations can further include and controlling each of the autonomous light electric vehicles of the plurality to the cluster location. The one or more additional properties associated with the plurality of autonomous light electric vehicles can include one or more of: an estimated travel distance for an autonomous light electric vehicle of the plurality to travel to the cluster location, an estimated time to travel to the cluster location for an autonomous light electric vehicle of the plurality, an estimated amount of energy expended for an autonomous light electric vehicle of the plurality to travel to the cluster location, an obstacle in a surrounding environment of an autonomous light electric vehicle of the plurality, a charge level of an autonomous light electric vehicle of the plurality, an operational status of an autonomous light electric vehicle of the plurality, an autonomous navigation capability of an autonomous light electric vehicle of the plurality, a time of day, or an operational constraint.

Another example aspect of the present disclosure is directed to an autonomous light electric vehicle. The autonomous light electric vehicle can include one or more processors and one or more tangible, non-transitory, computer readable media that store instructions that when executed by the one or more processors cause the one or more processors to perform operations. The operations can include receiving a respective location for one or more follower autonomous light electric vehicles. The operations can further include autonomously travelling to the respective location for each of the one or more follower autonomous light electric vehicles. The operations can further include collecting each of the one or more follower autonomous light electric vehicles. The operations can further include autonomously travelling to a cluster location. Collecting each of the one or more follower autonomous light electric vehicles can include coupling the respective follower autonomous light electric vehicle to the point autonomous light electric vehicle or travelling to within a signal range of the respective follower autonomous light electric vehicle to allow the respective follower autonomous light electric vehicle to autonomously follow the autonomous light electric vehicle.

Other aspects of the present disclosure are directed to various computing systems, vehicles, apparatuses, tangible, non-transitory, computer-readable media, and computing devices.

The technology described herein can help improve the safety of passengers of an autonomous LEV, improve the safety of the surroundings of the autonomous LEV, improve the experience of the rider and/or operator of the autonomous LEV, as well as provide other improvements as described herein. Moreover, the autonomous LEV technology of the present disclosure can help improve the ability of an autonomous LEV to effectively provide vehicle services to others and support the various members of the community in which the autonomous LEV is operating, including persons with reduced mobility and/or persons that are underserved by other transportation options. Additionally, the autonomous LEV of the present disclosure may reduce traffic congestion in communities as well as provide alternate forms of transportation that may provide environmental benefits.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example autonomous light electric vehicle computing system according to example aspects of the present disclosure;

FIG. 2 depicts an example autonomous light electric according to example aspects of the present disclosure;

FIG. 3A depicts an example image of a walkway and street according to example aspects of the present disclosure;

FIG. 3B depicts an example image segmentation of the example image of the walkway and street according to example aspects of the present disclosure;

FIG. 4 depicts an example navigation method for an autonomous light electric vehicle to example aspects of the present disclosure;

FIG. 5A depicts an example geographic area with a plurality of autonomous light electric vehicles according to example aspects of the present disclosure;

FIG. 5B depicts example cluster location selection and an example navigational control method for a plurality of autonomous light electric vehicles according to example aspects of the present disclosure;

FIG. 5C depicts an example cluster location selection and example navigational control method using a point autonomous light electric vehicle according to example aspects of the present disclosure;

FIG. 6 depicts an example method according to example aspects of the present disclosure;

FIG. 7 depicts an example method according to example aspects of the present disclosure; and

FIG. 8 depicts example system components according to example aspects of the present disclosure.

### DETAILED DESCRIPTION

Example aspects of the present disclosure are directed to systems and methods for clustering autonomous light electric vehicles (LEVs) using location data and/or other data associated with the autonomous LEVs. For example, an autonomous LEV can be an electric-powered bicycle, scooter, or other light vehicle, and can be configured to operate in a variety of operating modes, such as a manual mode in which a human operator controls operation, a semi-autonomous mode in which a human operator provides some operational input, or a fully autonomous mode in which the autonomous LEV can drive, navigate, operate, etc. without human operator input.

LEVs have increased in popularity in part due to their ability to help reduce congestion, decrease emissions, and provide convenient, quick, and affordable transportation options, particularly within densely populated urban areas. For example, in some implementations, a rider can rent a LEV to travel a relatively short distance, such as several blocks in a downtown area. However, due to potential logistical, operational, and/or regulatory constraints, LEVs may occasionally need to be repositioned when not in use. For example, a municipality may place restrictions on where LEVs can be parked, such as by requiring LEVs to be parked in designated parking locations. However, upon a rider reaching his or her destination, the rider may leave the LEV in an unauthorized parking location, and therefore the LEV may need to be repositioned into a designated parking location. Similarly, LEVs may occasionally need to be collected by a fleet manager, such as to redistribute the LEVs to better meet rider demand or for battery charging, but infrastructure constraints may require charging equipment or transportation equipment to only be accessible in particular locations. Thus, the LEVs may need to be repositioned and/or clustered together to allow for more convenient collection, supply positioning/repositioning, repairing, recharging, etc.

The systems and methods of the present disclosure can allow for LEVs to be repositioned by, for example, clustering a plurality of LEVs at a particular location. For example, to assist with autonomous operation, an autonomous LEV can include various sensors. Such sensors can include inertial measurement sensors (e.g., accelerometers), magnetometers, cameras (e.g., fisheye cameras, infrared cameras, etc.), radio beacon sensors (e.g., Bluetooth low energy sensors), GPS sensors (e.g., GPS receivers/transmitters), radio sensors (cellular, WiFi, V2X, etc.), ultrasonic sensors, and/or other sensors configured to obtain data indicative of an environment in which the autonomous LEV is operating.

According to example aspects of the present disclosure, a computing system can obtain data indicative of a location from a plurality of autonomous LEVs. For example, in some implementations, the computing system can be a remote computing system, and each of a plurality of autonomous LEVs can send the autonomous LEVs respective location to the remote computing system, such as over a communications network. For example, an autonomous LEV can upload location data (e.g., GPS data) to a remote computing device via a communication device (e.g., a cellular transmitter) over a communications network.

Further, the computing system can determine a cluster location for a plurality of autonomous LEVs based at least in part on the location data. For example, in some implementations, a subset of autonomous LEVs within a geographic area can be clustered together. The geographic area can be, for example, an area bounded by one or more streets, such as a city block. In some implementations, a plurality of cluster locations can be determined (e.g., two cluster locations on a city block), and a respective subset of autonomous LEVs can be clustered at each cluster location.

In some implementations, the cluster location can further be determined based at least in part on one or more additional properties associated with the autonomous LEVs. For example, the one or more additional properties can include one or more of: an estimated travel distance for an autonomous LEV to travel to the cluster location, an estimated time to travel to the cluster location for an autonomous LEV, an estimated amount of energy expended for an autonomous LEV to travel to the cluster location, an obstacle in a surrounding environment of an autonomous LEV, a charge level of an autonomous LEV, an operational status of an autonomous LEV, an autonomous navigation capability of an autonomous LEV, a time of day, and/or an operational constraint.

In some implementations, a cluster location can be determined based at least in part on an aggregated (e.g., summed) property, such as a summation of the respective estimated travel distance for each autonomous LEV to travel to the cluster location, a summation of the respective estimated time for each autonomous LEV to travel to the cluster location, and/or a summation of the respective estimated amount of energy expended for the autonomous LEVs to travel to the cluster. In some implementations, the cluster location can be selected to minimize the total distance travelled, total travel time, and/or total energy expended.

In some implementations, the cluster location can be a designated LEV parking location, a LEV charging station, a LEV collection point, and/or the current location of an autonomous LEV. For example, a plurality of autonomous LEVs can be clustered in a designated parking location to await collection, recharging, repairing, or repositioning by a fleet manager.

The computing system can then control each autonomous LEV to the cluster location. For example, in some implementations, the computing system can determine one or more navigational instructions for each respective autonomous LEV to travel to the cluster location. For example, the computing system can analyze an image obtained from a camera onboard an autonomous LEV to determine a ground plane, locate the cluster location within the ground plane, and then determine one or more navigational instructions for the autonomous LEV to travel to the cluster location. The one or more navigational instructions can then be communicated to each respective autonomous LEV. In some implementations, the cluster location can be communicated to each autonomous LEV, and each autonomous LEV can autonomously travel to the cluster location.

In some implementations, the computing system can determine a point autonomous LEV and one or more follower autonomous LEVs. In some implementations, the point autonomous LEV can be selected based on one or more properties of the autonomous LEVs. For example, an autonomous LEV with the highest charge level or an enhanced computing system (e.g., an enhanced autonomous navigation capability) can be selected as the point autonomous LEV.

The point autonomous LEV can then be controlled to collect each follower autonomous LEV. For example, in some implementations, the point autonomous LEV can autonomously travel to each follower autonomous LEV to collect the follower autonomous LEV. As an example, in some implementations, the point autonomous LEV can couple to a follower autonomous LEV (e.g., via a mechanical coupling device, electromagnetic coupling device, etc.) and then travel to the cluster location with the one or more follower autonomous LEVs in tow. In some implementations, a point autonomous LEV can couple to a plurality of follower autonomous LEVs, such as in a single file line or with the follower autonomous LEVs in a parallel orientation with one another.

In some implementations, the point autonomous LEV can include a visual fiducial (e.g., a unique identifier visibly positioned on the point autonomous LEV) which can be recognized by the follower autonomous LEVs. For example, each follower autonomous LEV can be configured to recognize and track the fiducial, and autonomously follow the point autonomous LEV to the cluster location.

In some implementations, the point autonomous LEV can travel to within a signal communication range and communicate one or more navigational instructions to a follower autonomous LEV.

In some implementations, a remote teleoperator can provide input to the computing system, such as selecting which follower autonomous LEVs the point autonomous LEV is to travel to, and the point autonomous LEV can be controlled based at least in part on the teleoperator input, such as by autonomously travelling to the follower autonomous LEVs selected by the teleoperator.

The systems and methods of the present disclosure can provide any number of technical effects and benefits. For example, by enabling autonomous LEVs to cluster together, more efficient collection, recharging, repairing, or repositioning of autonomous LEVs can be achieved, thereby reducing the amount of time required to collect the autonomous LEVs. More particularly, a computing system can obtain data indicative of a respective location for each of a plurality of autonomous LEVs and determine at least a subset of the autonomous LEVs to cluster within a geographic area based at least in part on the location data. The computing system can then determine a point autonomous LEV and one or more follower autonomous LEVs, and control each of the follower autonomous LEVs to within a threshold distance of the point autonomous LEV. For example, in some implementations, the point autonomous LEV can collect each of the follower autonomous LEVs, while in other implementations, each follower autonomous LEV can autonomously navigate to the point autonomous LEV. This can allow for autonomous LEVs to be clustered together, thereby reducing the time and labor required to collect the autonomous LEVs. Moreover, by selecting a cluster location in an authorized area, such as a designated LEV parking location, the autonomous LEVs can be clustered in compliance with applicable regulatory requirements.

Additionally, a cluster location can be selected to further increase efficiency, such as by intelligently clustering autonomous LEVs to minimize the total distance travelled or the amount of energy expended to cluster the autonomous LEVs. Further, in implementations in which a point autonomous LEV is used, computational resources can be conserved by reducing and/or eliminating the amount of autonomous navigation required by the follower autonomous LEVs to reach a cluster location. Thus, the systems and methods of the present disclosure can allow for the efficient clustering of autonomous LEVs.

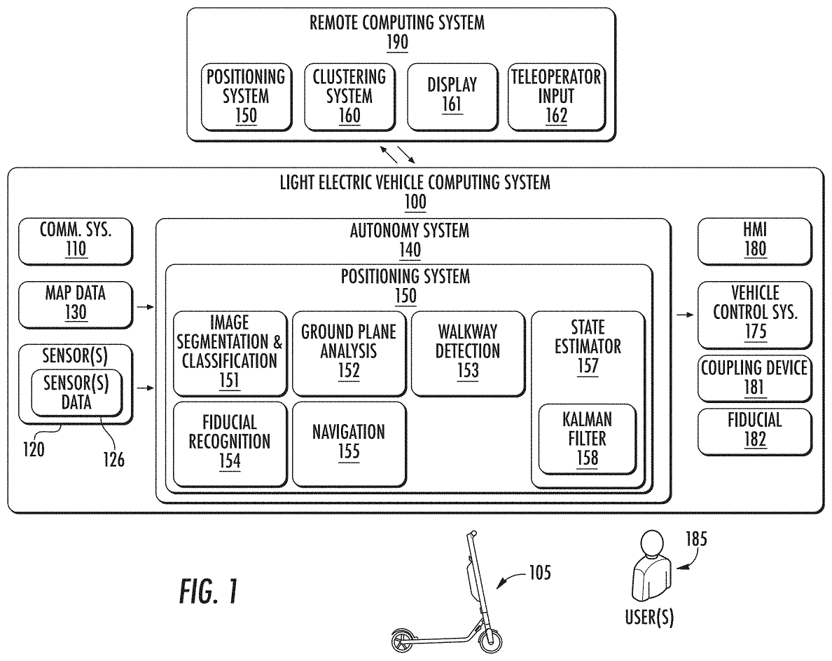

With reference now to the FIGS., example aspects of the present disclosure will be discussed in further detail. FIG. 1 illustrates an example LEV computing system 100 according to example aspects of the present disclosure. The LEV computing system 100 can be associated with an autonomous LEV 105. The LEV computing system 100 can be located onboard (e.g., included on and/or within) the autonomous LEV 105.

The autonomous LEV 105 incorporating the LEV computing system 100 can be various types of vehicles. For instance, the autonomous LEV 105 can be a ground-based autonomous LEV such as an electric bicycle, an electric scooter, an electric personal mobility vehicle, etc. The autonomous LEV 105 can travel, navigate, operate, etc. with minimal and/or no interaction from a human operator (e.g., rider/driver). In some implementations, a human operator can be omitted from the autonomous LEV 105 (and/or also omitted from remote control of the autonomous LEV 105). In some implementations, a human operator can be included in and/or associated with the autonomous LEV 105, such as a rider and/or a remote teleoperator.

In some implementations, the autonomous LEV 105 can be configured to operate in a plurality of operating modes. The autonomous LEV 105 can be configured to operate in a fully autonomous (e.g., self-driving) operating mode in which the autonomous LEV 105 is controllable without user input (e.g., can travel and navigate with no input from a human operator present in the autonomous LEV 105 and/or remote from the autonomous LEV 105). The autonomous LEV 105 can operate in a semi-autonomous operating mode in which the autonomous LEV 105 can operate with some input from a human operator present in the autonomous LEV 105 (and/or a human teleoperator that is remote from the autonomous LEV 105). The autonomous LEV 105 can enter into a manual operating mode in which the autonomous LEV 105 is fully controllable by a human operator (e.g., human rider, driver, etc.) and can be prohibited and/or disabled (e.g., temporary, permanently, etc.) from performing autonomous navigation (e.g., autonomous driving). In some implementations, the autonomous LEV 105 can implement vehicle operating assistance technology (e.g., collision mitigation system, power assist steering, etc.) while in the manual operating mode to help assist the human operator of the autonomous LEV 105.

The operating modes of the autonomous LEV 105 can be stored in a memory onboard the autonomous LEV 105. For example, the operating modes can be defined by an operating mode data structure (e.g., rule, list, table, etc.) that indicates one or more operating parameters for the autonomous LEV 105, while in the particular operating mode. For example, an operating mode data structure can indicate that the autonomous LEV 105 is to autonomously plan its motion when in the fully autonomous operating mode. The LEV computing system 100 can access the memory when implementing an operating mode.

The operating mode of the autonomous LEV 105 can be adjusted in a variety of manners. For example, the operating mode of the autonomous LEV 105 can be selected remotely, off-board the autonomous LEV 105. For example, a remote computing system 190 (e.g., of a vehicle provider and/or service entity associated with the autonomous LEV 105) can communicate data to the autonomous LEV 105 instructing the autonomous LEV 105 to enter into, exit from, maintain, etc. an operating mode. By way of example, such data can instruct the autonomous LEV 105 to enter into the fully autonomous operating mode. In some implementations, the operating mode of the autonomous LEV 105 can be set onboard and/or near the autonomous LEV 105. For example, the LEV computing system 100 can automatically determine when and where the autonomous LEV 105 is to enter, change, maintain, etc. a particular operating mode (e.g., without user input). Additionally, or alternatively, the operating mode of the autonomous LEV 105 can be manually selected via one or more interfaces located onboard the autonomous LEV 105 (e.g., key switch, button, etc.) and/or associated with a computing device proximate to the autonomous LEV 105 (e.g., a tablet operated by authorized personnel located near the autonomous LEV 105). In some implementations, the operating mode of the autonomous LEV 105 can be adjusted by manipulating a series of interfaces in a particular order to cause the autonomous LEV 105 to enter into a particular operating mode. In some implementations, the operating mode of the autonomous LEV 105 can be selected via a user's computing device (not shown), such as when a user 185 uses an application operating on the user computing device (not shown) to access or obtain permission to operate an autonomous LEV 105, such as for a short-term rental of the autonomous LEV 105. In some implementations, a fully autonomous mode can be disabled when a human operator is present.

In some implementations, the remote computing system 190 can communicate indirectly with the autonomous LEV 105. For example, the remote computing system 190 can obtain and/or communicate data to and/or from a third party computing system, which can then obtain/communicate data to and/or from the autonomous LEV 105. The third party computing system can be, for example, the computing system of an entity that manages, owns, operates, etc. one or more autonomous LEVs. The third party can make their autonomous LEV(s) available on a network associated with the remote computing system 190 (e.g., via a platform) so that the autonomous vehicles LEV(s) can be made available to user(s) 185.

The LEV computing system 100 can include one or more computing devices located onboard the autonomous LEV 105. For example, the computing device(s) can be located on and/or within the autonomous LEV 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the autonomous LEV 105 (e.g., its computing system, one or more processors, etc.) to perform operations and functions, such as those described herein for determining navigational instructions for the autonomous LEV 105, etc.

The autonomous LEV 105 can include a communications system 110 configured to allow the LEV computing system 100 (and its computing device(s)) to communicate with other computing devices. The LEV computing system 100 can use the communications system 110 to communicate with one or more computing device(s) that are remote from the autonomous LEV 105 over one or more networks (e.g., via one or more wireless signal connections). For example, the communications system 110 can allow the autonomous LEV to communicate and receive data from a remote computing system 190 of a service entity (e.g., an autonomous LEV rental entity), a third party computing system, a computing system of another autonomous LEV (e.g., a computing system onboard the other autonomous LEV), and/or a user computing device (e.g., a user's smart phone). In some implementations, the communications system 110 can allow communication among one or more of the system(s) on-board the autonomous LEV 105. The communications system 110 can include any suitable components for interfacing with one or more network(s), including, for example, transmitters, receivers, ports, controllers, antennas, and/or other suitable components that can help facilitate communication.

As shown in FIG. 1, the autonomous LEV 105 can include one or more vehicle sensors 120, an autonomy system 140, a positioning system 150 (e.g., a component of an autonomy system 140 or a stand-alone positioning system 150), one or more vehicle control systems 175, a human machine interface 180, a coupling device 181, a fiducial 182, and/or other systems, as described herein. One or more of these systems can be configured to communicate with one another via a communication channel. The communication channel can include one or more data buses (e.g., controller area network (CAN)), on-board diagnostics connector (e.g., OBD-II), Ethernet, and/or a combination of wired and/or wireless communication links. The onboard systems can send and/or receive data, messages, signals, etc. amongst one another via the communication channel.

The vehicle sensor(s) 120 can be configured to acquire sensor data 125. The vehicle sensor(s) 120 can include a Light Detection and Ranging (LIDAR) system, a Radio Detection and Ranging (RADAR) system, one or more cameras (e.g., fisheye cameras, visible spectrum cameras, infrared cameras, etc.), magnetometers, ultrasonic sensors, wheel encoders (e.g., wheel odometry sensors), steering angle encoders, positioning sensors (e.g., GPS sensors), inertial measurement sensors (e.g., accelerometers), radio beacon sensors (e.g., Bluetooth low energy sensors), radio sensors (e.g., cellular, WiFi, V2x, etc. sensors), motion sensors, and/or other types of imaging capture devices and/or sensors. The sensor data 125 can include inertial measurement unit/accelerometer data, image data (e.g., camera data), RADAR data, LIDAR data, ultrasonic sensor data, radio beacon sensor data, GPS sensor data, and/or other data acquired by the vehicle sensor(s) 120. This can include sensor data 125 associated with the surrounding environment of the autonomous LEV 105. For example, a fisheye camera can be a forward-facing fisheye camera, and can be configured to obtain image data which includes one or more portions of the autonomous LEV 105 and the orientation and/or location of the one or more portions of the autonomous LEV 105 in the surrounding environment. The sensor data 125 can also include sensor data 125 associated with the autonomous LEV 105. For example, the autonomous LEV 105 can include inertial measurement unit(s) (e.g., gyroscopes and/or accelerometers), wheel encoders, steering angle encoders, and/or other sensors.

In addition to the sensor data 125, the LEV computing system 100 can retrieve or otherwise obtain map data 130. The map data 130 can provide information about the surrounding environment of the autonomous LEV 105. In some implementations, an autonomous LEV 105 can obtain detailed map data that provides information regarding: the identity and location of different walkways, walkway sections, and/or walkway properties (e.g., spacing between walkway cracks); the identity and location of different radio beacons (e.g., Bluetooth low energy beacons); the identity and location of different position identifiers (e.g., QR codes visibly positioned in a geographic area); the identity and location of different LEV designated parking locations; the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, etc.); data indicative of events (e.g., scheduled concerts, parades, etc.); the location of collection points (e.g., LEV fleet pickup/dropoff locations); the location of charging stations; a rider location (e.g., the location of a rider requesting an autonomous LEV 105); one or more supply positioning locations (e.g., locations for the autonomous LEV 105 to be located when not in use in anticipation of demand); and/or any other map data that provides information that assists the autonomous LEV 105 in comprehending and perceiving its surrounding environment and its relationship thereto. In some implementations, the LEV computing system 100 can determine a vehicle route for the autonomous LEV 105 based at least in part on the map data 130.

In some implementations, the map data 130 can include an image map, such as an image map generated based at least in part on a plurality of images of a geographic area. For example, in some implementations, an image map can be generated from a plurality of aerial images of a geographic area. For example, the plurality of aerial images can be obtained from above the geographic area by, for example, an air-based camera (e.g., affixed to an airplane, helicopter, drone, etc.). In some implementations, the plurality of images of the geographic area can include a plurality of street view images obtained from a street-level perspective of the geographic area. For example, the plurality of street-view images can be obtained from a camera affixed to a ground-based vehicle, such as an automobile. In some implementations, the image map can be used by a visual localization model to determine a location of an autonomous LEV 105.

In some implementations, the positioning system 150 can obtain/receive the sensor data 125 from the vehicle sensor(s), and determine one or more navigational instructions for the autonomous LEV 105. In some implementations, the positioning system 150 can determine a location (also referred to as a position) of the autonomous LEV 105. For example, the positioning system 150 can use GPS data, map data, radio beacon data, or other positioning data to determine the position of the autonomous LEV 105. In some implementations, the positioning system 150 can determine one or more navigational instructions for the autonomous LEV 105 without first determining a position of the autonomous LEV 105.

The positioning system 150 can be any device or circuitry for determining a position of the autonomous LEV 105 and/or one or more navigational instructions (e.g., a motion plan) for the autonomous LEV 105. As shown, in some implementations, the positioning system 150 can be included in or otherwise a part of an autonomy system 140. In some implementations, a positioning system 150 can be a standalone positioning system 150. Additionally, as shown in FIG. 1, in some implementations, a remote computing system 190 can include a positioning system 150. For example, sensor data 125 (e.g., image data, GPS data, location data, etc.) from one or more sensors 120 of an autonomous LEV 105 can be communicated to the remote computing system 190 via the communications system 110, such as over a communications network.

In some implementations, the positioning system 150 can determine one or more navigational instructions for the autonomous LEV 105 based at least in part on the sensor data 125 obtained from the vehicle sensor(s) 120 located onboard the autonomous LEV 105. In some implementations, the positioning system 150 can use various models, such as purpose-built heuristics, algorithms, machine-learned models, etc. to determine the one or more navigational instructions. The various models can include computer logic utilized to provide desired functionality. For example, in some implementations, the models can include program files stored on a storage device, loaded into a memory and executed by one or more processors. In other implementations, the models can include one or more sets of computer-executable instructions that are stored in a tangible computer-readable storage medium such as RAM hard disk, flash storage, or optical or magnetic media. In some implementations, the one or more models can include machine-learned models, such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

For example, in some implementations, the positioning system 150 can include an image segmentation and classification model 151. The image segmentation model 151 can segment or partition an image into a plurality of segments, such as, for example, a foreground, a background, a walkway, sections of a walkway, roadways, various objects (e.g., vehicles, people, trees, benches, tables, etc.), or other segments.

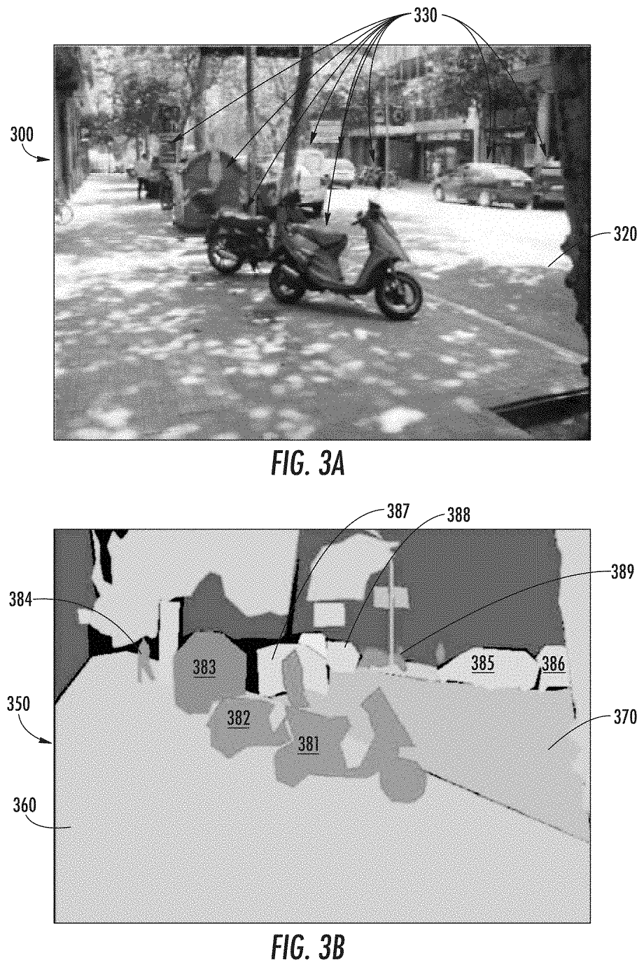

In some implementations, the image segmentation and classification model 151 can be trained using training data comprising a plurality of images labeled with various objects and aspects of each image. For example, a human reviewer can annotate a training dataset which can include a plurality of images with ground planes, walkways, sections of a walkway, roadways, various objects (e.g., vehicles, pedestrians, trees, benches, tables), etc. The human reviewer can segment and annotate each image in the training dataset with labels corresponding to each segment. For example, walkways and/or walkway sections (e.g., frontage zone, furniture zone, a pedestrian throughway, bicycle lane) in the images in the training dataset can be labeled, and the image segmentation and classification model 151 can be trained using any suitable machine-learned model training method (e.g., back propagation of errors). Once trained, the image segmentation and classification model 151 can receive an image, such as an image from a fisheye camera located onboard an autonomous LEV 105, and can segment the image into corresponding segments. An example of an image segmented into objects, roads, and a walkway using an example image segmentation and classification model 151 is depicted in FIGS. 3A and 3B.

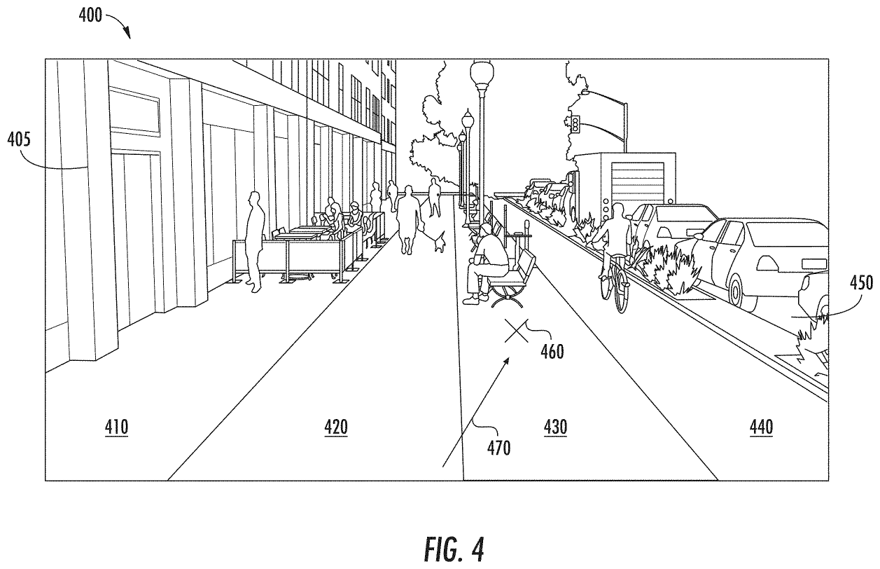

In some implementations, the positioning system 150 can include a ground plane analysis model 152. For example, an image can be segmented using an image segmentation and classification model 151, and a ground plane analysis model 152 can determine which segments of the image correspond to a ground plane (e.g., a navigable surface on which the autonomous LEV can travel). The ground plane analysis model 152 can be trained to detect a ground plane in an image, and further, to determine various properties of the ground plane, such as relative distances between objects positioned on the ground plane, which parts of a ground plane are navigable (e.g., can be travelled on), and other properties. In some implementations, the ground plane analysis model 152 can be included in or otherwise a part of an image segmentation and classification model 151. In some implementations, the ground plane analysis model 152 can be a stand-alone ground plane analysis model 152, such as a lightweight ground plane analysis model 152 configured to be used onboard the autonomous LEV 105. Example images with corresponding ground planes are depicted in FIGS. 3A, 3B, and 4.

In some implementations, the positioning system 150 can use walkway detection model 153 to determine that the autonomous LEV 105 is located on a walkway or to detect a walkway nearby. For example, the positioning system 150 can use accelerometer data and/or image data to detect a walkway. For example, as the autonomous LEV 105 travels on a walkway, the wheels of the autonomous LEV 105 will travel over cracks in the walkway, causing small vibrations to be recorded in the accelerometer data. The positioning system 150 can analyze the accelerometer data for a walkway signature waveform. For example, the walkway signature waveform can include periodic peaks repeated at relatively regular intervals, which can correspond to the acceleration caused by travelling over the cracks. In some implementations, the positioning system 150 can determine that the autonomous LEV 105 is located on a walkway by recognizing the walkway signature waveform. In some implementations, the walkway detection model 153 can use map data 130, such as map data 130 which can includes walkway crack spacing data, to detect the walkway. In some implementations, the walkway detection model 153 can use speed data to detect the walkway, such as speed data obtained via GPS data, wheel encoder data, speedometer data, or other suitable data indicative of a speed.

In some implementations, the walkway detection model 153 can determine that the autonomous LEV 105 is located on or near a walkway based at least in part on one or more images obtained from a camera located onboard the autonomous LEV 105. For example, an image can be segmented using an image segmentation and classification model 151, and the walkway detection model 153 can be trained to detect a walkway or walkway sections. In some implementations, the walkway detection model 153 can be included in or otherwise a part of an image segmentation and classification model 151. In some implementations, the walkway detection model 153 can be a stand-alone walkway detection model 153, such as a lightweight walkway detection model 153 configured to be used onboard the autonomous LEV 105. An example image with a walkway segmented into a plurality of sections is depicted in FIG. 4.

In some implementations, the walkway detection model 153 can determine that the autonomous LEV is located on a walkway and/or a particular walkway section based on the orientation of the walkway and/or walkway sections in an image. For example, in some implementations, an image captured from a fisheye camera can include a perspective view of the autonomous LEV 105 located on the walkway or show the walkway on both a left side and a right side of the autonomous LEV 105, and therefore indicate that the autonomous LEV 105 is located on the walkway (and/or walkway section).

In some implementations, the walkway detection model 153 can be used to determine an authorized section of a travel way in which the autonomous LEV 105 is permitted to travel. For example, the walkway detection model 153 can analyze the ground plane to identify various sections of a travelway (e.g., a bicycle lane section of a sidewalk), and the navigation model 155 can determine one or more navigational instructions for the autonomous LEV 105 to travel in the authorized section of the travel way. For example, the one or more navigational instructions can include one or more navigational instructions for the autonomous LEV 105 to travel to the authorized travelway and, further, to travel along the authorized travelway.

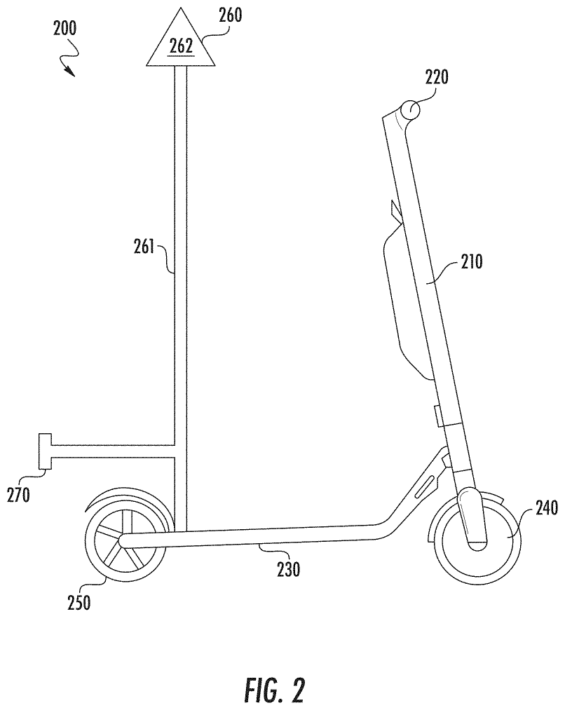

The positioning system 150 can also include a fiducial recognition model 154. For example, the fiducial recognition model 154 can be configured to recognize a fiducial 182 associated with an autonomous LEV 105. For example, a fiducial 182 can include various visual markers, such as a high contrast unique identifier visibly positioned on an autonomous LEV 105. For example, as described in greater detail with respect to FIG. 2, a fiducial recognition model 154 on a follower autonomous LEV 105 can recognize a fiducial 182 of a point autonomous LEV 105. Further, the positioning system 150 can determine one or more navigational instructions for the follower autonomous LEV 105 to follow the point autonomous LEV 105 (e.g., by following the fiducial 182). In some implementations, the fiducial recognition model can recognize a fiducial path, such as a high-contrast fiducial marking an authorized travelway for the autonomous LEV 105. In some implementations, the fiducial 182 can be a permanent fiducial (e.g., a sticker, QR code, etc.), while in other implementations, the fiducial 182 can be a temporary fiducial (e.g., a light, infrared emitter, display screen, etc.).

The positioning system 150 can also include a navigation model 155. The navigational model 155 can be configured to determine one or more navigational instructions for the autonomous LEV 105. The one or more navigational instructions can be used by the autonomous LEV 105 for autonomous travel. For example, the one or more navigational instructions can be used by an autonomous LEV 105 to navigate to a cluster location or to another autonomous LEV 105.

In some implementations, the one or more navigational instructions can include one or more dead-reckoning instructions, vector-based instructions, and/or waypoints. The one or more navigational instructions can essentially be a trajectory through space, and can use local coordinates relative to the autonomous LEV 105. In some implementations, the one or more navigational instructions can be determined agnostic of a determination of the current position of the autonomous LEV 105. For example, the one or more navigational instructions can be one or more directions relative to the current position of the autonomous LEV 105. As an example, the one or more navigational instructions can include a direction to travel (e.g. a heading) and a distance to travel relative to the current position of the autonomous LEV 105.

In some implementations, the navigation model 155 can determine one or more navigational instructions to travel to a particular location and/or towards the particular location, such as a cluster location. As an example, the one or more navigational instructions can include one or more navigational instructions associated with repositioning the autonomous LEV 105 within a threshold distance (e.g., 5 meters) of another autonomous LEV (e.g., a point autonomous LEV), at a LEV designated parking location, a LEV charging station, a LEV collection point, a LEV rider location, and/or a LEV supply positioning location. In some implementations, the navigation model 155 can simulate the implementation of the one or more navigational instructions by the autonomous LEV 105 to analyze the one or more navigational instructions.

In some implementations, the one or more navigational instructions can include all navigational instructions for autonomously travelling to the particular location. For example, the one or more navigational instructions can include instructions to navigate to a walkway or other path (e.g., a fiducial path), instructions to follow the walkway, and instructions to travel from the walkway to a cluster location.

In some implementations, the one or more navigational instructions can include a portion of navigational instructions to navigate towards the particular location. For example, the one or more navigational instructions may only be for a limited time period, such as a 30 second travel window, and upon completion of the one or more navigational instructions or the time period elapsing, subsequent navigational instructions can be determined, such as using subsequently obtained sensor data.

In some implementations, the one or more navigational instructions determined by the navigation model 155 can include one or more navigational instructions to travel to a fiducial path. For example, an image segmentation classification model 151, a ground plane analysis model 152, and/or a walkway detection model 153 can be used to detect a fiducial path depicted in an image. For example, a bicycle lane which includes a magnetic strip can be identified in an image, and the navigation model 155 can determine one or more navigational instructions to navigate to the fiducial path. Further, the one or more navigational instructions can include one or more navigational instructions to travel along at least a portion of the fiducial path. For example, the autonomous LEV 105 can travel according to one or more navigational instructions to a fiducial path, and once the fiducial path has been detected, such as by a fiducial recognition model 155, the autonomous LEV 105 can travel along the fiducial path according to the one or more navigational instructions. In some implementations, the one or more navigational instructions can further include one or more navigational instructions to travel from the fiducial path to a particular location. For example, the autonomous LEV 105 can travel to the fiducial path, along the fiducial path, and then leave the fiducial path to travel to a desired location, such as a cluster location.

In some implementations, the one or more navigational instructions can be determined on board the autonomous LEV 105. For example, a clustering system 160 operating on the remote computing system 190 can determine a cluster location, and can communicate the cluster location to the autonomous LEV 105. The positioning system 150 can then determine one or more navigational instructions for the autonomous LEV 105 to autonomously travel to the cluster location.

In some implementations, the one or more navigational instructions can be determined by the remote computing system 190 (e.g., a positioning system 150 of the remote computing system 190). For example, image data obtained by an autonomous LEV 105 can be uploaded to the remote computing system 190, the remote computing system 190 can determine the one or more navigational instructions, and the remote computing system 190 can communicate the one or more navigational instructions to the autonomous LEV 105.

In some implementations, the positioning system 150 can include a state estimator 157. For example, the state estimator can be configured to receive sensor data from a plurality of sensors and/or models 151-155 to aid in determining the one or more navigational instructions for the autonomous LEV 105. In some implementations, the state estimator 157 can be a Kalman filter 158.

For example, the state estimator 157 can be used to help determine the one or more navigational instructions. As an example, data from various sensors onboard the autonomous LEV 105, such as a wheel odometry sensor, a camera, an IMU, and/or a steering angle encoder, can be used to track the travel of the autonomous LEV 105 as the autonomous LEV 105 travels in accordance with the one or more navigational instructions.

As noted, in some implementations, the positioning system 150 can be included as a part of the autonomy system 140. In some implementations, the autonomy system 140 can obtain the sensor data 125 from the vehicle sensor(s) 120 to perceive its surrounding environment, predict the motion of objects within the surrounding environment, and generate an appropriate motion plan through such surrounding environment.

The one or more navigational instructions can then be implemented by the vehicle control system 175. The autonomy system 140 (and/or the positioning system 150) can communicate with the one or more vehicle control systems 175 to autonomously operate the autonomous LEV 105 (e.g., such as according to one or more navigational instructions). As an example, the one or more vehicle control systems 175 can control a steering actuator to orient the autonomous LEV 105 in a particular direction and can power one or more drive wheels to travel a particular distance.

In some implementations, the autonomous LEV 105 can use additional sensor data while travelling according to the one or more navigational instructions. For example, the autonomous LEV 105 can use short-range ultrasonic sensor data to help ensure the autonomous LEV 105 does not bump into anything in front of the autonomous LEV 105 while travelling according to the one or more navigational instructions. Similarly, the autonomous LEV 105 can use image data (e.g., camera data) to detect and avoid pedestrians in the path of the vehicle.

The autonomous LEV 105 can include an HMI (“Human Machine Interface”) 180 that can output data for and accept input from a user 185 of the autonomous LEV 105. The HMI 180 can include one or more output devices such as display devices, speakers, tactile devices, etc. In some implementations, the HMI 180 can provide notifications to a rider, such as when a rider is violating a walkway restriction.

In some implementations, the autonomous LEV 105 can include a coupling device 181. For example, the coupling device 181 can be configured to couple to one or more other autonomous LEVs 105. As an example, a first autonomous LEV 105 (e.g., a point autonomous LEV 105) can include a Janney style, electromagnetic, or other type of coupling device 181 on a rear portion of the autonomous LEV 105. A second autonomous LEV 105 (e.g., a follower autonomous LEV 105) can include a corresponding coupling device 181 on a front portion of the autonomous LEV 105. The two coupling devices 181 can be used to couple the first and second autonomous LEVs 105 together, such that the first autonomous LEV 105 can autonomously travel with the second autonomous LEV 105 in tow. An example coupling device 181 is depicted in FIG. 2

In some implementations, the autonomous LEV 105 can include a fiducial 182. As noted herein, the fiducial 182 can include various visual markers, such as a high contrast unique identifier visibly positioned on an autonomous LEV 105. For example, as described in greater detail with respect to FIG. 2, a fiducial recognition model 154 on a follower autonomous LEV 105 can recognize a fiducial 182 of a point autonomous LEV 105 and follow the point autonomous LEV 105.

The remote computing system 190 can include one or more computing devices that are remote from the autonomous LEV 105 (e.g., located off-board the autonomous LEV 105). For example, such computing device(s) can be components of a cloud-based server system and/or other type of computing system that can communicate with the LEV computing system 100 of the autonomous LEV 105, another computing system (e.g., a vehicle provider computing system, etc.), a user computing system (e.g., rider's smartphone), etc. The remote computing system 190 can be or otherwise included in a data center for the service entity, for example. The remote computing system 190 can be distributed across one or more location(s) and include one or more sub-systems. The computing device(s) of a remote computing system 190 can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the operations computing system (e.g., the one or more processors, etc.) to perform operations and functions, such as communicating data to and/or obtaining data from vehicle(s), and determining one or more navigational instructions for an autonomous LEV 105.

As shown in FIG. 1, the remote computing system 190 can include a positioning system 150, as described herein. In some implementations, the remote computing system 190 can determine one or more navigational instructions for the autonomous LEV 105 based at least in part on sensor data 125 communicated from the autonomous LEV 105 to the remote computing system 190. For example, the remote computing system 190 can control an autonomous LEV 105 by communicating one or more commands (e.g., one or more navigational instructions or instructions to travel to a particular location, such as a cluster location) to the autonomous LEV 105, and the autonomous LEV 105 can implement the one or more commands.

For example, in some implementations, an autonomous LEV 105 can upload sensor data (e.g., image data, position data, etc.) to the remote computing system 190. The remote computing system 190, and more particularly, the positioning system 150 and/or the clustering system 160, can then determine one or more navigational instructions and/or a cluster location for the autonomous LEV 105 based at least in part on the uploaded sensor data.

As shown in FIG. 1, the remote computing system 190 can also include a clustering system 160. The clustering system 160 can determine a location for a plurality of autonomous LEVs 105 to cluster. As used herein, the term “cluster” refers to grouping a plurality of autonomous LEVs 105 together. For example, the autonomous LEVs can be clustered by controlling the autonomous LEVs to within a threshold distance of one another, such as at a cluster location.

For example, the remote computing system 190 can obtain data indicative of a respective location for each of a plurality of autonomous LEVs 105. In some implementations, the data indicative of an autonomous LEVs 105 location can be obtained from each respective autonomous LEV 105. For example, an autonomous LEV 105 can communicate the location of the autonomous LEV 105 to the remote computing system 190, such as over a communication network. The data indicative of the location of an autonomous LEV 105 can be, for example, sensor data obtained by the autonomous LEV 105 (e.g., image data, GPS data, beacon data, etc.) and/or a specific location (e.g., a two-dimensional position on a map, a three-dimensional location in space, etc.), such as a location determined by a positioning system onboard an autonomous LEV 105.

In some implementations, the clustering system 160 of the remote computing system 190 can determine at least a subset of the plurality of autonomous LEVs 105 to cluster within a geographic area based at least in part on the data indicative of the respective location for each of the plurality of autonomous LEVs 105. In some implementations, the clustering system 160 can obtain the respective location of each autonomous LEV 105 from another source. For example, the remote computing system 190 and/or the clustering system 160 can be configured to track each autonomous LEV 105 in a fleet, such as via a GPS system.

In some implementations, the geographic area in which the plurality of autonomous LEVs are clustered can be a contiguous area bounded by one or more streets. For example, the remote computing system 190 can determine which autonomous LEVs 105 are located on a particular city block (e.g., a subset of the plurality of autonomous LEVs 105 located on the city block), and determine one or more cluster locations on the city block to cluster the autonomous LEVs 105. In this way, a plurality of autonomous LEVs 105 can be clustered together without requiring any of the autonomous LEVs 105 to cross a street.

In some implementations, the clustering system 160 can determine a point autonomous LEV 105 based at least in part on one or more properties of the plurality of autonomous LEVs 105 (or a subset thereof). For example, in some implementations, the point autonomous LEV can be an autonomous LEV 105 of the plurality (or the subset) to which each of the other autonomous LEVs 105 in the plurality (or the subset) travel to. Stated differently, the location of the point autonomous LEV 105 can be designated a cluster location. The clustering system 160 can then determine one or more follower autonomous LEVs 105. For example, the one or more follower LEVs 105 can be selected to travel to the point autonomous LEV 105. Each of the follower autonomous LEVs 105 can then be controlled by the clustering system 162 within a threshold distance of the point autonomous LEV 105. For example, in some implementations, the clustering system 160 can communicate a command to each follower autonomous LEV 105 to travel to the location of the point autonomous LEV 105. The command can include, for example, the location of the point autonomous LEV 105. A positioning system 150 on board each follower autonomous LEV 105 can then determine one or more navigational instructions to travel to within a threshold distance (e.g., 5 meters) of the point autonomous LEV 105, and autonomously travel to the point autonomous LEV 105. In this way, the remote computing system 190 can control each of the follower autonomous LEVs 105 to within the threshold distance of the point autonomous LEV 105.

In some implementations, the positioning system 150 of the remote computing system 190 can determine one or more navigational instructions for each follower autonomous LEV 105, and can communicate the one or more navigational instructions to each respective follower autonomous LEV 105, such as over a communications network. Each follower autonomous LEV 105 can then travel according to the one or more navigational instructions to within the threshold distance of the point autonomous LEV 105. Similarly, in this way, the remote computing system 190 can also control each of the follower autonomous LEVs 105 to within the threshold distance of the point autonomous LEV 105.

In some implementations, the clustering system 160 can control each of the follower autonomous LEVs 105 to within the threshold distance of the point autonomous LEV 105 by controlling the point autonomous LEV 105 to collect each follower autonomous LEV 105. For example, in some implementations, the clustering system 160 can send one or more commands to the point autonomous LEV 105 to collect the one or more follower autonomous LEVs 105. In some implementations, the one or more commands can include the location of each follower autonomous LEV 105. In some implementations, the one or more commands can include one or more navigational instructions for traveling to each respective follower autonomous LEV 105.

The point autonomous LEV 105 can then collect each follower autonomous LEV 105 according to the one or more commands communicated by the clustering system 160. For example, in some implementations, the point autonomous LEV 105 can couple to the one or more follower autonomous LEVs 105. For example, as described herein, the point autonomous LEV 105 can include a coupling device 181 configured to couple to a respective coupling device 181 of the one or more follower autonomous LEVs 105. In this way, the remote computing system 190 can control a follower autonomous LEV 105 to within a threshold distance of a point autonomous LEV 105.

In some implementations, the point autonomous LEV 105 can collect the one or more follower autonomous LEVs by traveling to within a signal range of the one or more follower autonomous LEVs 105. For example, in some implementations, the signal range can be a visual signal range for a fiducial 182 associated with the point autonomous LEV. For example, the point autonomous LEV 105 can autonomously travel to a follower autonomous LEV 105. The follower autonomous LEV 105 can be sent a command by the clustering system 160 to follow the point autonomous LEV 105. The follower autonomous LEV 105 can then use a fiducial recognition model 154 to recognize the fiducial 182 of the point autonomous LEV 105. The point autonomous LEV 105 can then autonomously travel to a cluster location determined by the remote computing system 190 (e.g., by the clustering system 160). The follower autonomous LEV 105 can then follow the point autonomous LEV 105 by tracking the fiducial 182 of the point autonomous LEV 105 using the fiducial recognition model 154. For example, the follower autonomous LEV 105 can periodically obtain image data of the surrounding environment, and identify the fiducial 182 of the point autonomous LEV 105 using the fiducial recognition model 154. The navigation model 155 can determine one or more navigational instructions to follow the point autonomous LEV 105. In this way, the follower autonomous LEV 105 can autonomously follow the point autonomous LEV 105, and the point autonomous LEV 105 can collect the follower autonomous LEV.

In some implementations, the point autonomous LEV 105 can collect a follower autonomous LEV 105 by traveling to within a signal communication range associated with communication between the point autonomous LEV 105 and the follower autonomous LEV 105. For example, both the point autonomous LEV 105 and the follower autonomous LEV 105 can include a communication system 110 configured to communicate with one another. The point autonomous LEV 105 can travel to within a signal communication range of the follower autonomous LEV 105, and then the point autonomous LEV 105 can communicate one or more navigational instructions to the follower autonomous LEV 105. For example, the point autonomous LEV 105 can determine one or more navigational instructions for both the point autonomous LEV 105 and the follower autonomous LEV 105 using a navigation model 155 and can communicate the one or more navigational instructions to the follower autonomous LEV 105. The point autonomous LEV 105 and the follower autonomous LEV 105 can then travel according to the one or more navigational instructions, such as to a cluster location. In this way, the remote computing system 190 can control the follower autonomous LEV 105 to autonomously follow the point autonomous LEV 105.

As noted, the clustering system 160 can determine the point autonomous LEV 105 and the one or more follower autonomous LEVs 105 based at least in part on one or more properties of the plurality of autonomous LEVs (or the subset thereof). For example, the one or more properties can include a location of an autonomous LEV 105, a charge level of an autonomous LEV 105, an operational status of an autonomous LEV 105, an autonomous navigation capability of an autonomous LEV 105, a time of day, and/or an operational constraint.

For example, an autonomous LEV 105 of the plurality (or the subset thereof) may be unable to travel (e.g., immobile) due to a low charge level or a mechanical issue affecting the operational status of the autonomous LEV 105. In such a situation, the clustering system 160 can select the immobile autonomous LEV 105 as a point autonomous LEV, and can control one or more follower autonomous LEVs 105 to the point LEV by, for example, communicating a command to the follower autonomous LEVs 105 to cluster within a threshold distance of the point autonomous LEV 105, and/or communicating one or more navigational instructions for autonomous travel to the point autonomous LEV 105 for each respective follower autonomous LEV 105. Stated differently, the clustering system 160 can select the location of the immobile autonomous LEV 105 as a cluster location, and can control one or more follower autonomous LEVs 105 to the cluster location.

Similarly, in some implementations, an autonomous LEV 105 of the plurality may have enhanced autonomous navigation capabilities. For example, an autonomous LEV 105 may have higher resolution or specialized sensors (e.g., LIDAR sensors, radar sensors, high resolution cameras, etc.) and/or improved computational abilities (e.g., faster processors, more memory, more accurate models, etc.) than the other autonomous LEVs 105 of the plurality. The clustering system 160 can select the enhanced autonomous LEV 105 as the point autonomous LEV 105, and the point autonomous LEV 105 can collect the one or more follower autonomous LEVs 105.

Additionally, in some implementations, a time of day or an operational constraint can be used to determine a point autonomous LEV 105 and one or more follower autonomous LEVs 105. For example, autonomous LEVs 105 may only be authorized to travel or cluster in certain areas at certain times of the day, such as due to regulatory requirements. Accordingly, the clustering system 160 can select an autonomous LEV 105 located in an authorized area (e.g., a designated parking location) as a point autonomous LEV 105 and/or a cluster location, and the one or more follower autonomous LEVs 105 can be controlled to the point autonomous LEV 105. Similarly, other operational constraints, such as obstacles (curbs, buildings, pedestrian traffic, etc.) in a surrounding environment of an autonomous LEV 105 can be used by the clustering system 160 to determine the point autonomous LEV 105 and the one or more follower autonomous LEVs 105.

As noted herein, in some implementations, the clustering system 160 can determine a cluster location. For example, the cluster location can be a location of an autonomous LEV 105 (e.g., the location of an autonomous LEV 105 selected as a point autonomous LEV 105). The cluster location can also be other locations, such as a designated parking location, an LEV charging station, a LEV collection point (e.g., a location authorized by a municipality for a fleet manager to collect the autonomous LEVs 105), or other suitable location. In some implementations, the clustering system 160 can determine the cluster location in conjunction with determining a point autonomous LEV 105 and one or more follower autonomous LEVs 105. In some implementations, the clustering system 160 can determine the cluster location without determining (e.g., selecting) a point autonomous LEV 105 and/or follower autonomous LEVs 105.

For example in some implementations, the cluster location can be determined based at least in part on data indicative of a respective location for each of a plurality of autonomous LEVs 105 and one or more additional properties associated with the plurality of autonomous LEVs 105. For example, the one or more additional properties can include an estimated travel distance for an autonomous LEV 105 to travel to the cluster location, an estimated time to travel to the cluster location for an autonomous LEV 105, an estimated amount of energy expended for an autonomous LEV to travel to the cluster location, an obstacle in a surrounding environment of an autonomous LEV 105, a charge level of an autonomous LEV 105, an operational status of an autonomous LEV 105, an autonomous navigation capability of an autonomous LEV 105, a time of day, and/or an operational constraint.

For example, in some implementations, the clustering system 160 can determine a cluster location for a plurality of autonomous LEVs 105 based at least in part on a summation of the respective estimated travel distance for each autonomous LEV to travel to the cluster location. For example, the clustering system 160 can select a plurality of autonomous LEVs 105 to cluster together. The clustering system 160 can then determine an estimated distance for each autonomous LEV 105 to travel to a possible cluster location. For example, the clustering system 160 can evaluate a plurality of cluster location candidates, such as designated collection points, LEV charging stations, designated parking locations, and/or other candidate cluster locations, such as street corners or areas in a furniture zone of a walkway. The clustering system 160 can then determine an estimated travel distance for each autonomous LEV 105 to travel to each candidate cluster location. Further, the clustering system can determine the cluster location based at least in part on a summation of the estimated travel distances for each of the autonomous LEVs 105 in the plurality. For example, a first candidate cluster location may require one of the autonomous LEVs to travel around an obstacle and therefore a longer estimated distance, whereas a second candidate cluster location may not. The clustering system 160 can sum the estimated travel distance for the plurality of autonomous LEVs 105 to travel to the first candidate cluster location and the second candidate cluster location, and can determine a cluster location based at least in part on the respective total estimated travel distances for the candidate cluster locations. For example, in some implementations, the candidate cluster location with the shorter estimated travel distance summation can be selected (e.g., the second candidate cluster location). In some implementations, the clustering system 160 can determine and select a cluster location with a minimum estimated travel distance summation.

In some implementations, the clustering system 160 can determine a cluster location for a plurality of autonomous LEVs 105 based at least in part on a summation of the respective estimated travel time for each autonomous LEV to travel to the cluster location. For example, the clustering system 160 can select a plurality of autonomous LEVs 105 to cluster together. The clustering system 160 can then determine an estimated time for each autonomous LEV 105 to travel to a possible cluster location. For example, the clustering system 160 can evaluate a plurality of cluster location candidates, such as designated collection points, LEV charging stations, designated parking locations, and/or other candidate cluster locations, such as street corners or areas in a furniture zone of a walkway. The clustering system 160 can then determine an estimated travel time for each autonomous LEV 105 to travel to each candidate cluster location. Further, the clustering system can determine the cluster location based at least in part on a summation of the estimated travel times for each of the autonomous LEVs 105 in the plurality. For example, a first candidate cluster location may require one of the autonomous LEVs 105 to travel in an area in which the autonomous LEV 105 must travel at a reduced travel speed and therefore travel for a longer estimated time, whereas a second candidate cluster location may not require the reduced travel speed. The clustering system 160 can sum the estimated travel time for the plurality of autonomous LEVs 105 to travel to the first candidate cluster location and the second candidate cluster location, and can determine a cluster location based at least in part on the respective total estimated travel times for the candidate cluster locations. For example, in some implementations, the candidate cluster location with the shorter estimated travel time summation can be selected (e.g., the second candidate cluster location). In some implementations, the clustering system 160 can determine and select a cluster location with a minimum estimated travel time summation.

In some implementations, the clustering system 160 can determine a cluster location for a plurality of autonomous LEVs 105 based at least in part on a summation of the respective estimated energy expended for each autonomous LEV to travel to the cluster location. For example, the clustering system 160 can select a plurality of autonomous LEVs 105 to cluster together. The clustering system 160 can then determine an estimated amount of energy expended for each autonomous LEV 105 to travel to a possible cluster location. For example, the clustering system 160 can evaluate a plurality of cluster location candidates, such as designated collection points, LEV charging stations, designated parking locations, and/or other candidate cluster locations, such as street corners or areas in a furniture zone of a walkway. The clustering system 160 can then determine an estimated amount of energy expended for each autonomous LEV 105 to travel to each candidate cluster location. Further, the clustering system can determine the cluster location based at least in part on a summation of the estimated energy expended for each of the autonomous LEVs 105 in the plurality. For example, a first candidate cluster location may require one of the autonomous LEVs 105 to travel up an incline (e.g., up a hill) or around an obstacle, whereas a second candidate cluster location may allow the autonomous LEV 105 to travel down a decline (e.g., down the hill) or in a direct line without navigating around the obstacle, reducing both computational energy and powered travel energy required to reach the candidate cluster location. The clustering system 160 can sum the estimated energy expended for the plurality of autonomous LEVs 105 to travel to the first candidate cluster location and the second candidate cluster location, and can determine a cluster location based at least in part on the respective total estimated energy expended for the candidate cluster locations. For example, in some implementations, the candidate cluster location with the reduced energy expenditure summation can be selected (e.g., the second candidate cluster location). In some implementations, the clustering system 160 can determine and select a cluster location with a minimum estimated energy expenditure summation.

In some implementations, the clustering system 160 can determine a cluster location based at least in part on an obstacle in a surrounding environment of an autonomous LEV 105 of the plurality. For example, obstacles can include curbs, steps, trees, sidewalk furniture, streets, etc. The clustering system 160 can determine a cluster location to allow for each autonomous LEV 105 of the plurality travel to the cluster location, thereby avoiding the obstacle(s).

In some implementations, the clustering system 160 can determine a cluster location to minimize a number of other actors (e.g., pedestrians, other LEVs, automobiles, etc.) the autonomous LEV 105 must navigate around. For example, the autonomous LEV can use real time (e.g., sensor data) and/or historical data about the frequency and density of other actors in a given geographic area, and select a cluster location which reduces and/or minimizes the number of other actors the autonomous LEV 105 must navigate around.

In some implementations, the clustering system 160 can determine a cluster location based at least in part on a charge level of an autonomous LEV 105 of the plurality. For example, an autonomous LEV 105 with a low charge level may be unable to travel to some cluster locations. In such a situation, the clustering system 160 can select a cluster location close enough to the autonomous LEV 105 to allow for the autonomous LEV 105 to travel to the cluster location.

In some implementations, the clustering system 160 can determine a cluster location based at least in part on an operational status of an autonomous LEV 105 of the plurality. For example, an autonomous LEV 105 may be inoperable, such as due to a depleted battery or a malfunction. In such a situation, the clustering system 160 can select a cluster location to allow for the autonomous LEVs 105 of the plurality to the cluster, such as the location of the inoperable autonomous LEV 105.

In some implementations, the clustering system can determine a cluster location based at least in part on an autonomous navigation capability of an autonomous LEV 105 of the plurality. For example, some autonomous LEVs 105 may have enhanced autonomous navigation capabilities, and thus may be able to more easily autonomously navigate to distant cluster locations, whereas autonomous LEVs 105 without the enhanced autonomous navigation capabilities may be able to more easily autonomously navigate to nearby cluster locations. In such a situation, the clustering system 160 can select a cluster location closer to the autonomous LEVs 105 without the enhanced autonomous navigation capabilities.

In some implementations, the clustering system 160 can determine a cluster location based at least in part on a time of day and/or an operational constraint. For example, certain municipalities may only allow clustering of autonomous LEVs 105 in certain areas at certain times of the day. In such a situation, the clustering system 160 can determine (e.g., select) a cluster location in compliance with such regulatory requirements.

In some implementations, the clustering system 160 can send the cluster location to the plurality of autonomous LEVs 105. For example, the remote computing system 190 can communicate one or more commands to each autonomous LEV 105 in a subset of autonomous LEVs 105 to cluster at a cluster location.

In some implementations, the clustering system 160 can provide the cluster location to a positioning system 150 operating on the remote computing system 190, and the remote computing system 190 can send one or more navigational instructions to each respective autonomous LEV 105. For example, the remote computing system 190 can communicate one or more navigational instructions to travel to a cluster location to each autonomous LEV 105 in a subset of autonomous LEVs 105.

In some implementations, the cluster location and/or the one or more navigational instructions can be determined based at least in part on a user input. For example, the remote computing system 190 can be associated with a teleoperator. The remote computing system 190 can include a display 161 configured to display the locations of a plurality of autonomous LEVs 105. The teleoperator can then select a particular cluster location for the autonomous LEVs 105. For example, in some implementations, the teleoperator can provide teleoperator input 162 indicative of the particular cluster location by clicking on an area in an image corresponding to the particular cluster location. For example, the teleoperator can click on a designated parking location in an image, and the clustering system 160 can select a corresponding cluster location based on the teleoperator input 162. In some implementations, the positioning system 150 can then determine one or more navigational instructions for the autonomous LEVs 105 to travel to the designated parking location, as described herein. In this way, the clustering system 160 can determine a cluster location based at least in part on teleoperator input 162.

In some implementations, the remote computing system 190 can simulate the implementation of the one or more navigational instructions by the autonomous LEV 105 to analyze the one or more navigational instructions. For example, a remote teleoperator can provide teleoperator input 162, and the remote computing system can use the positioning system 150 to simulate one or more possible navigational instructions to travel to the particular destination indicated by the teleoperator input 162. The positioning system 150 can then select one of the one or more navigational instructions, such as a set of navigational instructions which provided the best simulation results.

Once the remote computing system 190 has determined the cluster location and/or one or more navigational instructions for the autonomous LEVs 105, the remote computing system 190 can communicate the cluster location and/or the one or more navigational instructions to the autonomous LEVs 105. For example, in some implementations, a file (e.g., text file) can be communicated which can include a cluster location (e.g., GPS coordinates, local map grid coordinates, relative coordinates to a respective autonomous LEV 105), or the one or more navigational instructions, such as vector-based instructions, waypoints, dead-reckoning instructions, instructions to follow a fiducial path, and/or other navigational instructions. In some implementations, the cluster location, the location of one or more follower autonomous LEVs 105 and/or the one or more navigational instructions to the cluster location and/or one or more follower autonomous LEVs 105 can be communicated to a point autonomous LEV 105, as disclosed herein. Thus, for example, by communicating one or more commands, cluster locations, follower autonomous LEV 105 locations, and/or one or more navigational instructions, the remote computing system 190 can control a plurality of autonomous LEVs 105 to a cluster location and/or within a threshold distance of a point autonomous LEV 105.

Referring now to FIG. 2, a side-view perspective of an example autonomous LEV 200 according to example aspects of the present disclosure is depicted. For example, the autonomous LEV 200 depicted is an autonomous scooter. The autonomous LEV 200 can correspond to an autonomous LEV 105 depicted in FIG. 1. In some implementations, the autonomous LEV 200 can be used as a point autonomous LEV, as described herein.

As shown, the autonomous LEV 200 can include a steering column 210, a handlebar 220, a rider platform 230, a front wheel 240 (e.g., steering wheel), and a rear wheel 250 (e.g., drive wheel). For example, a rider can operate the autonomous LEV 200 in a manual mode in which the rider stands on the rider platform 230 and controls operation of the autonomous LEV 200 using controls on the handlebar 220. The autonomous LEV 200 can include various other components (not shown), such as sensors, actuators, batteries, computing devices, communication devices, and/or other components as described herein.

According to additional aspects of the present disclosure, the autonomous LEV 200 can further include a fiducial 260. For example, the fiducial 260 can correspond to a fiducial 182 described with respect to FIG. 1. The fiducial 260 can include various visual markers, such as a high contrast unique identifier visibly positioned on an autonomous LEV 105. For example, as shown in FIG. 2, the fiducial 260 can be visibly positioned on the autonomous LEV 200, such as at the top of an upright shaft 261. The fiducial 260 can further include a unique identifier 262, such as a QR code or other identifier.

In some implementations, the fiducial 260 can be a permanent fiducial. For example, the unique identifier 262 of the fiducial 260 can be a sticker, QR code, or other permanent marking affixed to the autonomous LEV 200. In some implementations, the fiducial 260 can be a temporary fiducial. For example, the fiducial 260 can be a light, infrared emitter, display screen, or other temporary fiducial which can be activated when the autonomous LEV 200 has been designated a point autonomous LEV, as described herein.

The unique identifier 262 can be recognized by a fiducial recognition model 154 on a follower autonomous LEV. For example, as a point autonomous LEV, the autonomous LEV 200 can travel to within a visual range of a follower autonomous LEV. In some implementations, the point autonomous LEV can communicate with the follower autonomous LEV to alert the follower autonomous LEV that the point autonomous LEV is nearby. In some implementations, a remote computing system can alert the follower autonomous LEV that the point autonomous LEV is nearby. The follower autonomous LEV can then obtain images of the follower autonomous LEVs surrounding environment, which can include fiducial 260 of the point autonomous LEV. A fiducial recognition model onboard the follower autonomous LEV can then recognize the fiducial 260, and further, a navigation model onboard the follower autonomous LEV can determine one or more navigational instructions to follow the point autonomous LEV. For example, the follower autonomous LEV can autonomously travel towards the point autonomous LEV and periodically obtain additional images and determine additional navigational instructions to travel towards the point autonomous LEV, and the point autonomous LEV can travel to the cluster location. In this way, a point autonomous LEV can collect a follower autonomous LEV, and the follower autonomous LEV can autonomously follower the point autonomous LEV.

According to additional aspects of the present disclosure, the autonomous LEV 200 can further include a coupling device 270. For example, coupling device 270 can correspond to a coupling device 181 described with respect to FIG. 1. For example, the coupling device 270 can be configured to couple to one or more other autonomous LEVs. As an example, the autonomous LEV 200 can be a point autonomous LEV, and the coupling device 270 can be a Janney style, electromagnetic, or other type of coupling device 270 positioned on a rear portion of the autonomous LEV 200. The autonomous LEV 200 can autonomously travel to a second autonomous LEV (e.g., a follower autonomous LEV), which can include a corresponding coupling device positioned on a front portion of the autonomous LEV. The two coupling devices 270 can be used to couple the point autonomous LEV 200 to the follower autonomous LEV such that the point autonomous LEV 200 can autonomously travel with the follower autonomous LEV in tow. In some implementations, two or more follower autonomous LEVs 200 can be coupled in single file with a point autonomous LEV. In some implementations, a point autonomous LEV 200 can include a coupling device 270 which can couple to a plurality of follower autonomous LEVs. For example, the coupling device 270 can include a bar with two or more coupling devices positioned on either end to allow for a plurality of follower autonomous LEVs to couple to the point autonomous LEV 200 in a parallel orientation.

Referring now to FIG. 3A, an example image 300 depicting a walkway 310, a street 320, and a plurality of objects 330 is depicted, and FIG. 3B depicts a corresponding semantic segmentation 350 of the image 300. For example, as shown, the semantically-segmented image 350 can be partitioned into a plurality of segments 360-389 corresponding to different semantic entities depicted in the image 300. Each segment 360-389 can generally correspond to an outer boundary of the respective semantic entity. For example, the walkway 310 can be semantically segmented into a distinct semantic entity 360, the road 320 can be semantically segmented into a distinct semantic entity 370, and each of the objects 330 can be semantically segmented into distinct semantic entities 381-389, as depicted. For example, semantic entities 381-384 are located on the walkway 360, whereas semantic entities 385-389 are located on the road 370. While the semantic segmentation depicted in FIG. 3 generally depicts the semantic entities segmented to their respective borders, other types of semantic segmentation can similarly be used, such as bounding boxes etc.

In some implementations, individual sections of a walkway 310 and/or a ground plane can also be semantically segmented. For example, an image segmentation and classification model 151, a ground plane analysis model 152, and/or a walkway detection model 153 depicted in FIG. 1 can be trained to semantically segment an image into one or more of a ground plane, a road, a walkway, etc. For example, a ground plane can include a road 370 and a walkway 360. Further, in some implementations, the walkway 360 can be segmented into various sections, as described in greater detail with respect to FIG. 4.

Referring now to FIG. 4, an example walkway 400 and walkway sections 410-440 according to example aspects of the present disclosure are depicted. As shown, a walkway 400 can be divided up into one or more sections, such as a first section (e.g., frontage zone 410), a second section (e.g., pedestrian throughway 420), a third section (e.g., furniture zone 430), and/or a fourth section (e.g., travel lane 440). The walkway 400 depicted in FIG. 4 can be, for example, a walkway depicted in an image obtained from a camera onboard an autonomous LEV, and thus from the perspective of the autonomous LEV.

A frontage zone 410 can be a section of the walkway 400 closest to one or more buildings 405. For example, the one or more buildings 405 can correspond to dwellings (e.g., personal residences, multi-unit dwellings, etc.), retail space (e.g., office buildings, storefronts, etc.) and/or other types of buildings. The frontage zone 410 can essentially function as an extension of the building, such as entryways, doors, walkway café s, sandwich boards, etc. The frontage zone 410 can include both the structure and the façade of the buildings 405 fronting the street 450 as well as the space immediately adjacent to the buildings 405.

The pedestrian throughway 420 can be a section of the walkway 400 that functions as the primary, accessible pathway for pedestrians that runs parallel to the street 450. The pedestrian throughway 420 can be the section of the walkway 400 between the frontage zone 410 and the furniture zone 430. The pedestrian throughway 420 functions to help ensure that pedestrians have a safe and adequate place to walk. For example, the pedestrian throughway 420 in a residential setting may typically be 5 to 7 feet wide, whereas in a downtown or commercial area, the pedestrian throughway 420 may typically be 8 to 12 feet wide. Other pedestrian throughways 420 can be any suitable width.

The furniture zone 430 can be a section of the walkway 400 between the curb of the street 450 and the pedestrian throughway 420. The furniture zone 430 can typically include street furniture and amenities such as lighting, benches, newspaper kiosks, utility poles, trees/tree pits, as well as light vehicle parking spaces, such as designated parking spaces for bicycles and LEVs.

Some walkways 400 may optionally include a travel lane 440. For example, the travel lane 440 can be a designated travel way for use by bicycles and LEVs. In some implementations, a travel lane 440 can be a one-way travel way, whereas in others, the travel lane 440 can be a two-way travel way. In some implementations, a travel lane 440 can be a designated portion of a street 450.

Each section 410-440 of a walkway 400 can generally be defined according to its characteristics, as well as the distance of a particular section 410-440 from one or more landmarks. For example, in some implementations, a frontage zone 410 can be the 6 to 8 feet closest to the one or more buildings 405. In some implementations, a furniture zone 430 can be the 6 to 8 feet closest to the street 450. In some implementations, the pedestrian throughway 420 can be the 5 to 12 feet in the middle of a walkway 400. In some implementations, each section 410-440 can be determined based upon characteristics of each particular section 410-440, such as by semantically segmenting an image using an image segmentation and classification model 151, a ground plane analysis model 152, and/or a walkway detection model 153 depicted in FIG. 1. For example, street furniture included in a furniture zone 430 can help to distinguish the furniture zone 430, whereas sandwich boards and outdoor seating at walkway café s can help to distinguish the frontage zone 410. In some implementations, the sections 410-440 of a walkway 400 can be defined, such as in a database. For example, a particular location (e.g., a position) on a walkway 400 can be defined to be located within a particular section 410-440 of the walkway 400 in a database, such as a map data 130 database depicted in FIG. 1. In some implementations, the sections 410-440 of a walkway 400 can have general boundaries such that the sections 410-440 may have one or more overlapping portions with one or more adjacent sections 410-440.

According to example aspects of the present disclosure, in some implementations, a computing system can determine a particular location 460 to reposition an autonomous LEV. For example, the particular location 460 can be a cluster location, such as a LEV designated parking location, a LEV charging station, a LEV collection point, a LEV rider location, or a LEV supply positioning location. As depicted in FIG. 4, the particular location 460 can be a designated parking location in a furniture zone 430 of a walkway 400. In some implementations, the particular location can be determined by a computing system, as described herein. In some implementations, a teleoperator can provide the particular location as an input. For example, the image depicted in FIG. 4 can be displayed on a display screen associated with the teleoperator, and the teleoperator can input the particular location, such as by clicking on the particular location on the display screen.

The computing system can then determine one or more navigational instructions for the autonomous LEV to travel to the particular location. For example, as depicted in FIG. 4, the one or more navigational instructions are represented as a travel vector 470. The travel vector 470 can indicate a direction of travel (e.g., a heading), and a distance to travel. As noted herein, other types of navigational instructions can similarly be used, such as dead-reckoning instructions, waypoint-based instructions, and/or other navigational instructions. The autonomous LEV can then travel according to the travel vector 470. In some implementations, the autonomous LEV can use one or more ultrasonic sensors while traveling along the travel vector 470 to help ensure the path in front of the autonomous LEV is clear. In some implementations, upon completing travel according to the travel vector 470, the computing system can obtain subsequent sensor data to confirm whether or not the autonomous LEV has traveled to the particular location 460. If not, one or more subsequent navigational instructions can be determined and the autonomous LEV can travel according to the one or more subsequent navigational instructions.

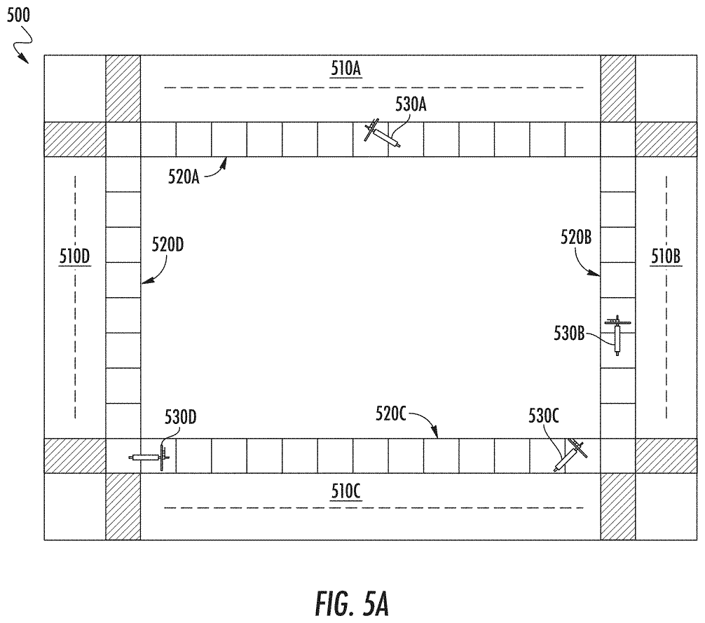

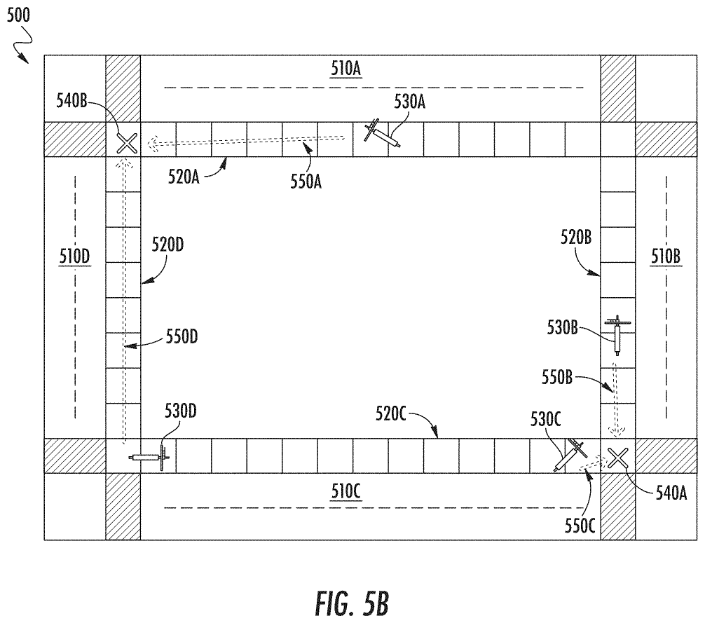

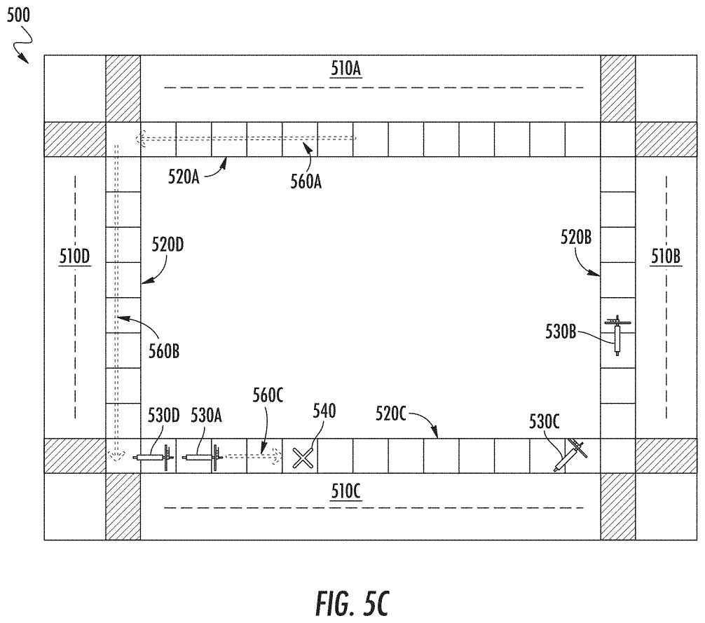

Referring now to FIGS. 5A-C, an example illustration of cluster location determination and repositioning is depicted according to example aspects of the present disclosure. For example, as depicted, a computing system (e.g., a remote computing system) can determine one or more cluster locations based at least in part on data indicative of a location of a plurality of autonomous LEVs 530.

For example, as shown in FIG. 5A, a plurality of autonomous LEVs 530A-D are located in a geographic area 500. As shown, the geographic area 500 can include a plurality of streets 510A-D. In some implementations, the geographic area 500 can be bounded by the one or more streets 510A-D. For example, the geographic area 500 can be a city block. The geographic area 500 can further include a plurality of walkways (e.g., sidewalks) 520A-D. For example, each of the sidewalks 520A-D can be adjacent to a respective street 510A-D, as shown.

The plurality of autonomous LEVs 530A-D can be positioned (e.g., located) within the geographic area. For example, in some implementations, the autonomous LEVs 530A-D can be available to be rented by riders, and the autonomous LEVs can be parked following usage by the riders. Thus, the autonomous LEVs 530A-D may become scattered throughout the geographic area 500 (and/or other adjoining geographic areas) based on rider usage. This scattering of the autonomous LEVs 530A-D can present a logistical problem, as the autonomous LEVS 530A-D may be parked in unauthorized parking areas, may have depleted batteries due to usage, and may be located far away from charging and collection infrastructure, such as designated collection points or LEV charging locations. Thus, in order to manage a fleet of autonomous LEVs 530A-D, a fleet owner may need to manually collect each autonomous LEV 530A-D, such as for overnight charging, which can require significant energy, time, and resources.

The systems and methods of the present disclosure, however, can allow for autonomous LEVs 530A-D to be clustered together, thereby reducing the amount of time and energy to collect them, while also helping to ensure compliance with applicable regulatory requirements. For example, FIG. 5B depicts an example clustering implementation for the autonomous LEVS 530A-D.

For example, a computing system (e.g., a remote computing system) can obtain data indicative of a respective location for each of a plurality of autonomous LEVs 530A-D. In some implementations, each of the autonomous LEVs 530A-D can communicate their respective location to the computing system, such as via a communication network. In some implementations, the computing system can be configured to monitor and track each of the autonomous LEVs 530A-D.

The computing system can then determine at least a subset of the plurality of autonomous LEVs 530A-D to cluster together. For example, in some implementations, all of the autonomous LEVs 530A-D (and/or additional autonomous LEVs) can be clustered within a geographic area at a single cluster location 540, while in other implementations, multiple cluster locations 540 can be determined, and a respective subset of the autonomous LEVs 530A-D can be clustered at each cluster location 540. In some implementations, the computing system can obtain a respective location for an entire fleet of autonomous LEVs, and can select at least a subset of autonomous LEVs 530A-D to cluster within a geographic area 500, such as a city block. One or more cluster locations 540 can be determined by the computing system using any of the methods described herein, such as based at least in part on the respective locations of the autonomous LEVs 530A-D and/or additional properties, such as an estimated travel distance for an autonomous LEV 530A-D to travel to a cluster location 540, an estimated time to travel to a cluster location 540 for an autonomous LEV 530A-D, an estimated amount of energy expended for an autonomous LEV 530A-D to travel to a cluster location 540, an obstacle in a surrounding environment of an autonomous LEV 530A-D, a charge level of an autonomous LEV 530A-D, an operational status of an autonomous LEV 530A-D, an autonomous navigation capability of an autonomous LEV 530A-D, a time of day, and/or an operational constraint. In some implementations, one or more cluster location 540 can be the location(s) of autonomous LEVs 530, LEV designated parking locations, LEV charging stations, and/or LEV collection points, as described herein.

For example, as shown in FIG. 5B, the computing system has determined two cluster locations 540A-B. Additionally, the computing system can determine which autonomous LEVs 530 to cluster at each cluster location 540. For example, as shown, autonomous LEVs 530B and 530C are to cluster at cluster location 540A, and autonomous LEVs 530A and 530D are to cluster at cluster location 540B.

In some implementations, the computing system can further determine one or more navigational instructions 550A for each respective autonomous LEV 530A-D to autonomously travel to a cluster location. For example, the computing system can determine (and communicate) one or more navigational instructions 550A (represented by a dashed arrow) for autonomous LEV 530A to autonomously travel to cluster location 540B. Similarly, one or more navigational instructions 550D can be determined for autonomous LEV 530D to autonomously travel to cluster location 540B, and respective navigational instructions 550B and 550C can be determined for autonomous LEVs 530B and 530C, respectively, to autonomously travel to cluster location 540A.

In some implementations, the computing system can communicate one or more commands to each respective autonomous LEV 530A-D to autonomously travel to the associated cluster location 540A-B. In some implementations, the one or more commands can include the respective associated cluster location 540A-B, and each autonomous LEV 530A-D can determine one or more respective navigational instructions 550A-D to autonomously travel to the associated cluster location 540A-B.

As shown in FIG. 5C, in some implementations, the computing system can determine a point autonomous LEV and one or more follower autonomous LEVs from the plurality of autonomous LEVs 530A-D. For example, as depicted in FIG. 5C, the autonomous LEV 530A has been selected by the computing system as the point autonomous LEV, and autonomous LEVs 530B-D have been selected by the computing system as follower autonomous LEVs. In some implementations, the point autonomous LEV and/or the follower autonomous LEVs can be determined based at least in part on a location of an autonomous LEV 530A-D, a charge level of an autonomous LEV 530A-D, an operational status of an autonomous LEV 530A-D, an autonomous navigation capability of an autonomous LEV 530A-D, a time of day, and/or an operational constraint. For example, autonomous LEV 530A may have enhanced autonomous navigation capabilities, and the computing system can select autonomous LEV 530A as the point autonomous LEV based at least in part on those enhanced navigation capabilities.

According to additional example aspects of the present disclosure, the point autonomous LEV (autonomous LEV 530A) can collect each of the follower autonomous LEVs (autonomous LEVs 530B-D). For example, as depicted in FIG. 5C, the autonomous LEV 530A can use a first set of navigational instructions 560A and a second set of navigational instructions 560B to navigate to autonomous LEV 530D. In some implementations, the autonomous LEV 530A can couple to autonomous LEV 530D, such as by using a coupling device. In some implementations, autonomous LEV 530A can navigate to within a signal range of autonomous LEV 530D, and autonomous LEV 530D can autonomously follow the autonomous LEV 530A. Autonomous LEV 530A can then use a third set of navigational instructions 560C to navigate to a cluster location 540 either with autonomous LEV 530D in tow or autonomously following autonomous LEV 530A. Similarly, autonomous LEV 530A can autonomously navigate to autonomous LEVs 530B and 530C, collect autonomous LEVs 530B and 530C, and autonomously navigate to the cluster location 540. In some implementations, autonomous LEV 530A can determine the navigational instructions 560A-C, while in other implementations, the remote computing system can determine and communicate the navigational instructions 560A-C to autonomous LEV 530A. In this way, the point autonomous LEV (autonomous LEV 530A) can collect and cluster the follower autonomous LEVs (autonomous LEVs 530B-D) at the cluster location 540.

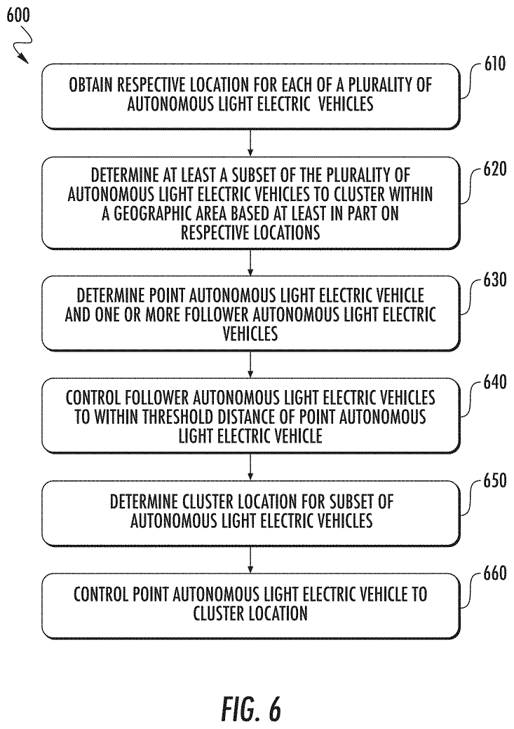

FIG. 6 depicts a flow diagram of an example method 600 for clustering autonomous LEVs according to example aspects of the present disclosure. One or more portion(s) of the method 600 can be implemented by a computing system that includes one or more computing devices such as, for example, the computing systems described with reference to the other figures (e.g., a LEV computing system 100, a remote computing system 190, etc.). Each respective portion of the method 600 can be performed by any (or any combination) of one or more computing devices. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 6 is described with reference to elements/terms described with respect to other systems and figures for example illustrated purposes and is not meant to be limiting. One or more portions of method 600 can be performed additionally, or alternatively, by other systems.

At 610, the method 600 can include obtaining a respective location (e.g., data indicative thereof) for each of a plurality of autonomous LEVs. For example, in some implementations, a remote computing system can monitor and track the respective position for a plurality of autonomous LEVs, such as a fleet of autonomous LEVs. In some implementations, each autonomous LEV in the plurality can communicate its respective location to the remote computing system, such as over a communication network.

At 620, the method 600 can include determining at least a subset of the plurality of autonomous LEVs to cluster within a geographic area based at least in part on the respective locations of the autonomous LEVs in the plurality. For example, in some implementations, the geographic area can include a contiguous area bounded by one or more streets, such as a city block. For example, clustering a plurality of autonomous LEVs on a city block can allow for easier collection, recharging, repairing, or repositioning without requiring any autonomous LEV to traverse a street.

At 630, the method 600 can include determining a point autonomous LEV and one or more follower autonomous LEVs based at least in part on one or more properties of the subset. For example, the one or more properties can include a location, a charge level, an operational status, an autonomous navigation capability, a time of day, and/or an operational constraint, as described herein.

At 640, the method 600 can include controlling each of the follower autonomous LEVs to within a threshold distance of the point autonomous LEV. For example, in some implementations, each follower autonomous LEV can be autonomously repositioned to within the threshold distance of point autonomous LEV. For example, a remote computing system can control a follower autonomous LEV by communicating one or more commands to the follower autonomous LEV. The one or more commands can include, for example, the location of the point autonomous LEV and/or one or more navigational instructions to autonomously travel to the point autonomous LEV. In some implementations, an onboard computing system of the follower autonomous LEV can determine one or more navigational instructions to travel to the point autonomous LEV upon receiving the location of the point autonomous LEV.

In some implementations, controlling each of the follower autonomous LEVs to within the threshold distance of the point autonomous LEV can include controlling the point autonomous LEV to collect each follower autonomous LEV. For example, in some implementations, the remote computing system can communicate one or more commands to the point autonomous LEV to collect each follower autonomous LEV. For example, the one or more commands can include the respective location for each autonomous LEV and/or one or more navigational instructions for autonomously traveling to each respective follower autonomous LEV.

In some implementations, the point autonomous LEV can couple to each follower autonomous LEV, such as by using a coupling device. In some implementations, the point autonomous LEV can be controlled to within a signal range of the follower autonomous LEVs and the follower autonomous LEVs can autonomously follow the point autonomous LEV. For example, the signal range can be a visual signal range for a fiducial associated with the point autonomous LEV or a signal communication range associated with communication between the point autonomous LEV and the follower autonomous LEV.

In some implementations, controlling the point autonomous LEV to collect each follower autonomous LEV can include obtaining control input from a remote teleoperator associated with controlling the point autonomous LEV to collect each follower autonomous LEV. For example, a remote teleoperator can select which follower autonomous LEVs the point autonomous LEV is to collect and/or an order in which the follower autonomous LEVs are to be collected. The remote computing system can then control the point autonomous LEV based at least in part on the control input by, for example, sending one or more commands to the point autonomous LEV, as described herein. For example, the remote computing system can communicate a list of follower autonomous LEV locations and/or associated navigational instructions to the point autonomous LEV.

At 650, the method 600 can include determining a cluster location for the subset of autonomous LEVs. For example, the cluster location can include an LEV designated parking location, an LEV charging station, an LEV collection point, an autonomous LEV location, and/or any other cluster location as described herein. In some implementations, the cluster location can be determined using additional properties, as described herein.

At 660, the method 600 can include controlling the point autonomous LEV to the cluster location. For example, the remote computing system can communicate one or more commands to the point autonomous LEV to autonomously travel to the cluster location. For example, the point autonomous LEV can collect one or more follower autonomous LEVs, and can autonomously navigate to the cluster location with the one or more follower autonomous LEVs in tow and/or autonomously following the point autonomous LEV.

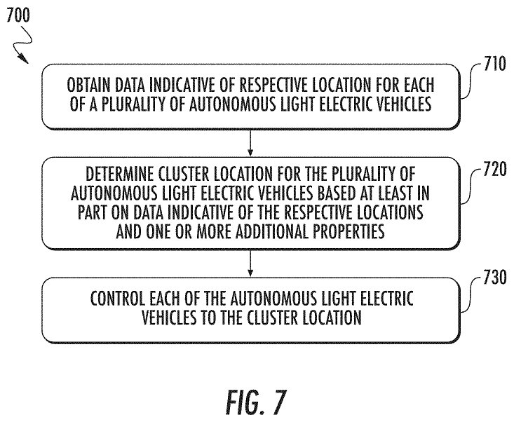

FIG. 7 depicts a flow diagram of an example method 700 for clustering autonomous LEVs according to example aspects of the present disclosure. One or more portion(s) of the method 700 can be implemented by a computing system that includes one or more computing devices such as, for example, the computing systems described with reference to the other figures (e.g., a LEV computing system 100, a remote computing system 190, etc.). Each respective portion of the method 700 can be performed by any (or any combination) of one or more computing devices. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 7 is described with reference to elements/terms described with respect to other systems and figures for example illustrated purposes and is not meant to be limiting. One or more portions of method 700 can be performed additionally, or alternatively, by other systems.

At 710 the method 700 can include obtaining data indicative of a respective location for each of a plurality of autonomous LEVs. For example, in some implementations, the autonomous LEVs can communicate their respective location to the computing system. In some implementations, the computing system can track (e.g., monitor) the location of each autonomous LEV of the plurality.

At 720, the method 700 can include determining a cluster location for the plurality of autonomous LEVs based at least in part on the data indicative of the respective location for each of the autonomous LEVs of the plurality and one or more additional properties associated with the plurality of autonomous LEVs. For example, the one or more additional properties associated with the plurality of autonomous LEVs can include an estimated travel distance for an autonomous LEV of the plurality to travel to the cluster location, an estimated time to travel to the cluster location for an autonomous LEV of the plurality, an estimated amount of energy expended for an autonomous LEV of the plurality to travel to the cluster location, an obstacle in a surrounding environment of an autonomous LEV of the plurality, a charge level of an autonomous LEV of the plurality, an operational status of an autonomous LEV of the plurality, an autonomous navigation capability of an autonomous LEV of the plurality, a time of day, and/or an operational constraint.

In some implementations, the cluster location can be the location of an autonomous LEV of the plurality, a LEV designated parking location, a LEV charging station, a LEV electric vehicle collection point, or other cluster location as described herein.

In some implementations, determining the cluster location for the plurality of autonomous LEVs based at least in part on the data indicative of the respective location for each of the autonomous LEVs of the plurality and the one or more additional properties associated with the plurality can include determining the cluster location for the plurality of autonomous LEVs based at least in part on a summation of the respective estimated travel distance for each autonomous LEV of the plurality to travel to the cluster location, a summation of the respective estimated time to travel to the cluster location for each of the autonomous LEVs of the plurality, and/or a summation of the respective estimated amount of energy expended for an autonomous LEV of the plurality to travel to the cluster location. For example, in some implementations, the computing system can determine the cluster location to minimize the total travel distance summation, the total travel time summation, and/or the total energy expenditure summation.

At 730, the method 700 can include controlling each of the autonomous LEVs of the plurality to the cluster location. For example, in some implementations, controlling an autonomous LEV of the plurality to the cluster location can include determining one or more navigational instructions to navigate the autonomous LEV to the cluster location and communicating the one or more navigational instructions to the autonomous LEV. In some implementations, controlling each of the autonomous LEVs of the plurality to the collection point can include determining a point autonomous LEV and one or more follower autonomous LEVs of the plurality and controlling the point autonomous LEV to collect each follower autonomous LEV, as described herein. For example, the point autonomous LEV can be an autonomous LEV of the plurality, and each of the autonomous LEVs of the plurality which are not the point autonomous LEV can each be a follower autonomous LEV.

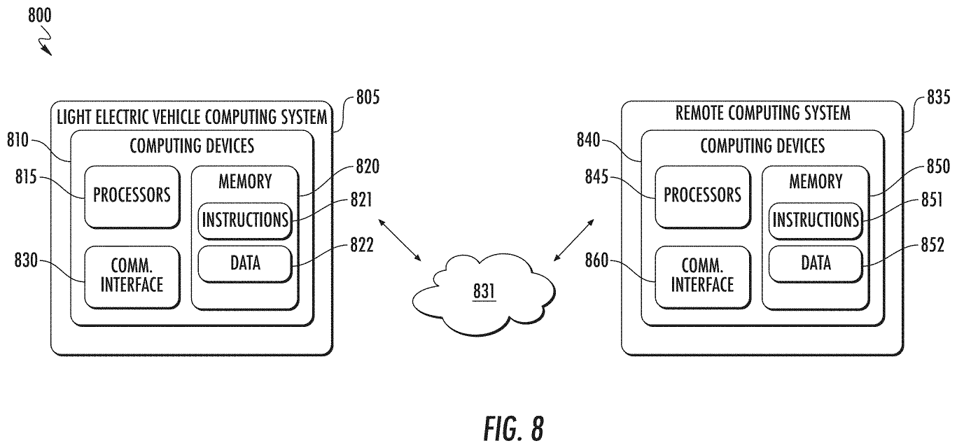

FIG. 8 depicts an example system 800 according to example aspects of the present disclosure. The example system 800 illustrated in FIG. 8 is provided as an example only. The components, systems, connections, and/or other aspects illustrated in FIG. 8 are optional and are provided as examples of what is possible, but not required, to implement the present disclosure. The example system 800 can include a light electric vehicle computing system 805 of a vehicle. The light electric vehicle computing system 805 can represent/correspond to the light electric vehicle computing system 100 described herein. The example system 800 can include a remote computing system 835 (e.g., that is remote from the vehicle computing system). The remote computing system 835 can represent/correspond to a remote computing system 190 described herein. The light electric vehicle computing system 805 and the remote computing system 835 can be communicatively coupled to one another over one or more network(s) 831.

The computing device(s) 810 of the light electric vehicle computing system 805 can include processor(s) 815 and a memory 820. The one or more processors 815 can be any suitable processing device (e.g., a processor core, a microprocessor, an ASIC, a FPGA, a controller, a microcontroller, etc.) and can be one processor or a plurality of processors that are operatively connected. The memory 820 can include one or more non-transitory computer-readable storage media, such as RAM, ROM, EEPROM, EPROM, one or more memory devices, flash memory devices, data registrar, etc., and combinations thereof.

The memory 820 can store information that can be accessed by the one or more processors 815. For instance, the memory 820 (e.g., one or more non-transitory computer-readable storage mediums, memory devices) on-board the vehicle can include computer-readable instructions 821 that can be executed by the one or more processors 815. The instructions 821 can be software written in any suitable programming language or can be implemented in hardware. Additionally, or alternatively, the instructions 821 can be executed in logically and/or virtually separate threads on processor(s) 815.

For example, the memory 820 can store instructions 821 that when executed by the one or more processors 815 cause the one or more processors 815 (the light electric vehicle computing system 805) to perform operations such as any of the operations and functions of the LEV computing system 100 (or for which it is configured), one or more of the operations and functions for determining a cluster location and/or point and follower autonomous LEVs, one or more portions of methods 600 and 700, and/or one or more of the other operations and functions of the computing systems described herein.

The memory 820 can store data 822 that can be obtained (e.g., acquired, received, retrieved, accessed, created, stored, etc.). The data 822 can include, for instance, sensor data, map data, regulatory data, vehicle state data, perception data, prediction data, motion planning data, autonomous LEV location data, cluster location data, travel distance data, travel time data, energy expenditure data, obstacle data, charge level data, operational status data, autonomous navigation capability data, time/data, operational constraint data, LEV charging location data, LEV designated parking location data, LEV collection point data, data associated with a vehicle client, data associated with a service entity's telecommunications network, data associated with an API, data associated with a library, data associated with user interfaces, data associated with user input, data associated with teleoperator input, and/or other data/information such as, for example, that described herein. In some implementations, the computing device(s) 810 can obtain data from one or more memories that are remote from the light electric vehicle computing system 805.

The computing device(s) 810 can also include a communication interface 830 used to communicate with one or more other system(s) on-board a vehicle and/or a remote computing device that is remote from the vehicle (e.g., of the system 835). The communication interface 830 can include any circuits, components, software, etc. for communicating via one or more networks (e.g., network(s) 831). The communication interface 830 can include, for example, one or more of a communications controller, receiver, transceiver, transmitter, port, conductors, software and/or hardware for communicating data.

The remote computing system 835 can include one or more computing device(s) 840 that are remote from the light electric vehicle computing system 805. The computing device(s) 840 can include one or more processors 845 and a memory 850. The one or more processors 845 can be any suitable processing device (e.g., a processor core, a microprocessor, an ASIC, a FPGA, a controller, a microcontroller, etc.) and can be one processor or a plurality of processors that are operatively connected. The memory 850 can include one or more tangible, non-transitory computer-readable storage media, such as RAM, ROM, EEPROM, EPROM, one or more memory devices, flash memory devices, data registrar, etc., and combinations thereof.

The memory 850 can store information that can be accessed by the one or more processors 845. For instance, the memory 850 (e.g., one or more tangible, non-transitory computer-readable storage media, one or more memory devices, etc.) can include computer-readable instructions 851 that can be executed by the one or more processors 845. The instructions 851 can be software written in any suitable programming language or can be implemented in hardware. Additionally, or alternatively, the instructions 851 can be executed in logically and/or virtually separate threads on processor(s) 845.

For example, the memory 850 can store instructions 851 that when executed by the one or more processors 845 cause the one or more processors 845 to perform operations such as any of the operations and functions of the remote computing system 190 (or for which it is configured), one or more of the operations and functions for determining one or more cluster locations and/or point and follower autonomous LEVs, one or more portions of methods 600 and 700, and/or one or more of the other operations and functions of the computing systems described herein.

The memory 850 can store data 852 that can be obtained. The data 852 can include, for instance, sensor data, map data, regulatory data, vehicle state data, perception data, prediction data, motion planning data, autonomous LEV location data, cluster location data, travel distance data, travel time data, energy expenditure data, obstacle data, charge level data, operational status data, autonomous navigation capability data, time/data, operational constraint data, LEV charging location data, LEV designated parking location data, LEV collection point data, data associated with a vehicle client, data associated with a service entity's telecommunications network, data associated with an API, data associated with a library, data associated with user interfaces, data associated with user input, data associated with teleoperator input, and/or other data/information such as, for example, that described herein.

The computing device(s) 840 can also include a communication interface 860 used to communicate with one or more system(s) onboard a vehicle and/or another computing device that is remote from the system 835, such as light electric vehicle computing system 805. The communication interface 860 can include any circuits, components, software, etc. for communicating via one or more networks (e.g., network(s) 831). The communication interface 860 can include, for example, one or more of a communications controller, receiver, transceiver, transmitter, port, conductors, software and/or hardware for communicating data.

The network(s) 831 can be any type of network or combination of networks that allows for communication between devices. In some embodiments, the network(s) 831 can include one or more of a local area network, wide area network, the Internet, secure network, cellular network, mesh network, peer-to-peer communication link and/or some combination thereof and can include any number of wired or wireless links. Communication over the network(s) 831 can be accomplished, for instance, via a communication interface using any type of protocol, protection scheme, encoding, format, packaging, etc.

Computing tasks, operations, and functions discussed herein as being performed at one computing system herein can instead be performed by another computing system, and/or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

The communications between computing systems described herein can occur directly between the systems or indirectly between the systems. For example, in some implementations, the computing systems can communicate via one or more intermediary computing systems. The intermediary computing systems may alter the communicated data in some manner before communicating it to another computing system.

The number and configuration of elements shown in the figures is not meant to be limiting. More or less of those elements and/or different configurations can be utilized in various embodiments.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for clustering a plurality of autonomous light electric vehicles, comprising:
obtaining, by a computing system comprising one or more computing devices, data indicative of a respective location for each of a plurality of autonomous light electric vehicles;
determining, by the computing system, at least a subset of the plurality of autonomous light electric vehicles to cluster within a geographic area based at least in part on the data indicative of the respective location for each of the plurality of autonomous light electric vehicles;
determining, by the computing system, a point autonomous light electric vehicle and one or more follower autonomous light electric vehicles based at least in part on one or more properties of the subset of the autonomous light electric vehicles, the point autonomous light electric vehicle comprising an autonomous light electric vehicle of the subset, each of the autonomous light electric vehicles of the subset which are not the point autonomous light electric vehicle comprising a follower autonomous light electric vehicle; and
controlling, by the computing system, each of the follower autonomous light electric vehicles to within a threshold distance of the point autonomous light electric vehicle.

2. The computer-implemented method of claim 1, wherein obtaining, by the computing system, the data indicative of the respective location for each of the plurality of autonomous light electric vehicles comprises receiving, by the computing system, the data indicative of the respective location for each autonomous light electric vehicle of the plurality from the respective autonomous light electric vehicle.

3. The computer-implemented method of claim 1, wherein the geographic area comprises a contiguous area bounded by one or more streets.

4. The computer-implemented method of claim 1, wherein the one or more properties of the subset of the autonomous light electric vehicles comprise one or more of: a location, a charge level, an operational status, an autonomous navigation capability, a time of day, and an operational constraint.

5. The computer-implemented method of claim 1, wherein controlling, by the computing system, each of the follower autonomous light electric vehicles to within the threshold distance of the point autonomous light electric vehicle comprises autonomously repositioning each follower autonomous light electric vehicle to within the threshold distance of the point autonomous light electric vehicle.

6. The computer-implemented method of claim 1, wherein controlling, by the computing system, each of the follower autonomous light electric vehicles to within the threshold distance of the point autonomous light electric vehicle comprises:
controlling, by the computing system, the point autonomous light electric vehicle to collect each follower autonomous light electric vehicle.

7. The computer-implemented method of claim 6, wherein controlling, by the computing system, the point autonomous light electric vehicle to collect each follower autonomous light electric vehicle comprises:
for each follower autonomous light electric vehicle:
controlling the point autonomous light electric vehicle to each follower autonomous light electric vehicle; and
coupling the follower autonomous light electric vehicle to the point autonomous light electric vehicle.

8. The computer-implemented method of claim 6, wherein controlling, by the computing system, the point autonomous light electric vehicle to collect each follower autonomous light electric vehicle comprises:
for each follower autonomous light electric vehicle:
controlling the point autonomous light electric vehicle to within a signal range of the follower autonomous light electric vehicle; and
autonomously following the point autonomous light electric vehicle with the follower autonomous light electric vehicle.

9. The computer-implemented method of claim 8, wherein the signal range comprises a visual signal range for a fiducial associated with the point autonomous light electric vehicle or a signal communication range associated with communication between the point autonomous light electric vehicle and the follower autonomous light electric vehicle.

10. The computer-implemented method of claim 6, wherein controlling, by the computing system, the point autonomous light electric vehicle to collect each follower autonomous light electric vehicle comprises:
obtaining, by the computing system, control input from a remote teleoperator associated with controlling the point autonomous light electric vehicle to collect each follower autonomous light electric vehicle; and
controlling, by the computing system, the point autonomous light electric vehicle to collect each follower autonomous light electric vehicle based at least in part on the control input.

11. The computer-implemented method of claim 1, further comprising:
determining, by the computing system, a cluster location for the subset of autonomous light electric vehicles; and
controlling, by the computing system, the point autonomous light electric vehicle to the cluster location.

12. The computer-implemented method of claim 11, wherein the cluster location comprises a light electric vehicle designated parking location, a light electric vehicle charging station, or a light electric vehicle collection point.

13. A computing system, comprising:
one or more processors; and
one or more tangible, non-transitory, computer readable media that store instructions that when executed by the one or more processors cause the computing system to perform operations, the operations comprising:
obtaining data indicative of a respective location for each of a plurality of autonomous light electric vehicles;
determining a cluster location for the plurality of autonomous light electric vehicles based at least in part on the data indicative of the respective location for each of the autonomous light electric vehicles of the plurality and one or more additional properties associated with the plurality of autonomous light electric vehicles; and
controlling each of the autonomous light electric vehicles of the plurality to the cluster location;
wherein the one or more additional properties associated with the plurality of autonomous light electric vehicles comprise one or more of: an estimated travel distance for an autonomous light electric vehicle of the plurality to travel to the cluster location, an estimated time to travel to the cluster location for an autonomous light electric vehicle of the plurality, an estimated amount of energy expended for an autonomous light electric vehicle of the plurality to travel to the cluster location, an obstacle in a surrounding environment of an autonomous light electric vehicle of the plurality, a charge level of an autonomous light electric vehicle of the plurality, an operational status of an autonomous light electric vehicle of the plurality, an autonomous navigation capability of an autonomous light electric vehicle of the plurality, a time of day, or an operational constraint.

14. The computing system of claim 13, wherein the cluster location comprises the location of an autonomous light electric vehicle of the plurality, a light electric vehicle designated parking location, a light electric vehicle charging station, or a light electric vehicle collection point.

15. The computing system of claim 13, wherein determining the cluster location for the plurality of autonomous light electric vehicles based at least in part on the data indicative of the respective location for each of the autonomous light electric vehicles of the plurality and the one or more additional properties associated with the plurality of autonomous light electric vehicles comprises:
determining the cluster location for the plurality of autonomous light electric vehicles based at least in part on a summation of the respective estimated travel distance for each autonomous light electric vehicle of the plurality to travel to the cluster location.

16. The computing system of claim 13, wherein determining the cluster location for the plurality of autonomous light electric vehicles based at least in part on the data indicative of the respective location for each of the autonomous light electric vehicles of the plurality and the one or more additional properties associated with the plurality of autonomous light electric vehicles comprises:
determining the cluster location for the plurality of autonomous light electric vehicles based at least in part on a summation of the respective estimated time to travel to the cluster location for each of the autonomous light electric vehicles of the plurality.

17. The computing system of claim 13, wherein determining the cluster location for the plurality of autonomous light electric vehicles based at least in part on the data indicative of the respective location for each of the autonomous light electric vehicles of the plurality and the one or more additional properties associated with the plurality of autonomous light electric vehicles comprises:
determining the cluster location for the plurality of autonomous light electric vehicles based at least in part on a summation of the respective estimated amount of energy expended for an autonomous light electric vehicle of the plurality to travel to the cluster location.

18. The computing system of claim 13, wherein controlling each of the autonomous light electric vehicles of the plurality to the cluster location comprises:
for each autonomous light electric vehicle of the plurality:
determining one or more navigational instructions to navigate the autonomous light electric vehicle to the cluster location; and
communicating the one or more navigational instructions to the autonomous light electric vehicle.

19. The computing system of claim 13, wherein controlling each of the autonomous light electric vehicles of the plurality to the collection point comprises:
determining a point autonomous light electric vehicle and one or more follower autonomous light electric vehicles of the plurality, the point autonomous light electric vehicle comprising an autonomous light electric vehicle of the plurality, each of the autonomous light electric vehicles of the plurality which are not the point autonomous light electric vehicle comprising a follower autonomous light electric vehicle; and
controlling the point autonomous light electric vehicle to collect each follower autonomous light electric vehicle.

20. An autonomous light electric vehicle comprising:
one or more processors; and
one or more tangible, non-transitory, computer readable media that store instructions that when executed by the one or more processors cause the one or more processors to perform operations, the operations comprising:
receiving a respective location for one or more follower autonomous light electric vehicles;
autonomously travelling to the respective location for each of the one or more follower autonomous light electric vehicles;
collecting each of the one or more follower autonomous light electric vehicles; and
autonomously travelling to a cluster location;
wherein collecting each of the one or more follower autonomous light electric vehicles comprises coupling the respective follower autonomous light electric vehicle to the point autonomous light electric vehicle or travelling to within a signal range of the respective follower autonomous light electric vehicle to allow the respective follower autonomous light electric vehicle to autonomously follow the autonomous light electric vehicle.
